(19) United States
(12) Patent Application Publication
(10) Pub. No.: US 2025/0242605 A1
(43) Pub. Date: Jul. 31, 2025

(54) PRINTING JIG AND PRINTER INCLUDING THE SAME

(71) Applicant: Roland DG Corporation, Hamamatsu-shi (JP)

(72) Inventors: Yoshiteru MIYAMOTO, Hamamatsu-shi (JP); Hidetoshi ATSUMI, Hamamatsu-shi (JP); Shohei YAMASHITA, Hamamatsu-shi (JP); Teruma OTSUKA, Hamamatsu-shi (JP); Hirokazu KAKEI, Hamamatsu-shi (JP)

(21) Appl. No.: 19/182,682

(22) Filed: Apr. 18, 2025

Related U.S. Application Data
(63) Continuation of application No. PCT/JP2022/038739, filed on Oct. 18, 2022.

(51) Int. Cl. B41J 3/407; B41J 25/308; B41J 29/393

(52) U.S. Cl. CPC B41J 3/40731; B41J 3/40733; B41J 25/308; B41J 29/393; B41J 2029/3935

(57) ABSTRACT

A printing jig includes first and second shafts to support a large-diameter cylindrical substrate and spaced from each other at a first interval, a rotator to rotate the first shaft and/or the second shaft, and a small-diameter support that is detachably attached from above and supported by the first and second shafts and is able to support a small-diameter cylindrical substrate. The small-diameter support includes a body, first and second shafts supported by the body, extending in a first direction, and spaced from each other at a second interval shorter than the first interval, and first and second rotary rollers supported by the first and second shafts, respectively, so as to be rotatable relative to the body, and movable to contact with a peripheral surface of the small-diameter cylindrical substrate and rotate with rotation of the first and second shafts.

### CROSS REFERENCE TO RELATED APPLICATIONS

This application claims the benefit of priority to PCT Application No. PCT/JP2022/38739 filed on Oct. 18, 2022. The entire contents of this application are incorporated herein by reference.

### BACKGROUND OF THE INVENTION

### 1. Field of the Invention

The present invention relates to printing jigs and printers including the printing jigs. The present invention particularly relates to printing jigs to be usable to print on cylindrical substrates, at least a portion of each of which has a cylindrical outer peripheral shape, while the cylindrical substrate is rotated, and also relates to printers including the printing jigs.

### 2. Description of the Related Art

JP H08-207265 A, for example, discloses a printing apparatus for cylindrical substrate printing that involves printing on a surface of a cylindrical substrate. The printing apparatus includes a first supporting shaft configured to be rotatable, a second supporting shaft arranged side by side with the first supporting shaft so as to be parallel to the first supporting shaft, an adjuster to adjust an interval between the first and second supporting shafts and heights of the first and second supporting shafts, and a printing unit disposed above the first and second supporting shafts and configured to discharge ink.

When printing is to be effected on the surface of the cylindrical substrate, the cylindrical substrate is placed between the first and second supporting shafts from above such that the cylindrical substrate is supported by the first and second supporting shafts. Then, ink is discharged from the printing unit while the cylindrical substrate is rotated by rotating the first supporting shaft. This enables printing on the surface of the cylindrical substrate.

In effecting printing on a small-diameter cylindrical substrate, the printing apparatus disclosed in JP H08-207265 A controls the adjuster such that the interval between the first and second supporting shafts decreases. In effecting printing on a large-diameter cylindrical substrate, the printing apparatus controls the adjuster such that the interval between the first and second supporting shafts increases. Adjusting the interval between the first and second supporting shafts in this manner enables printing on surfaces of cylindrical substrates different in diameter.

As described above, the printing apparatus disclosed in JP H08-207265 A is required to adjust the interval between the first and second supporting shafts every time printing is effected on a surface of a cylindrical substrate having a different diameter, which complicates control for adjusting the interval. If printing is to be effected on cylindrical substrates different in diameter, control for adjusting the interval between the first and second supporting shafts is preferably as simple as possible.

### SUMMARY OF THE INVENTION

Accordingly, example embodiments of the present invention provide printing jigs each of which is able to avoid complicated control when printing is effected on peripheral surfaces of cylindrical substrates which are different in diameter and at least portions of which have cylindrical outer peripheral shapes, and printers including the printing jigs.

A printing jig according to an example embodiment of the present invention is a printing jig for a printer including a supporting table, the printing jig being attachable to and detachable from the supporting table and usable to print on a cylindrical substrate while the cylindrical substrate is rotated, at least a portion of the cylindrical substrate having a cylindrical outer peripheral shape. The printing jig includes a jig body, a first shaft, a second shaft, a rotator, and a small-diameter support. The jig body is to be supported by the supporting table. The first shaft is supported by the jig body and extends in a first direction. The second shaft is supported by the jig body and is arranged side by side with the first shaft so as to be spaced from the first shaft at a first interval in a second direction intersecting with the first direction. The second shaft is able to, together with the first shaft, support a large-diameter cylindrical substrate having a first diameter. The rotator rotates at least one of the first shaft and the second shaft. The small-diameter support is to be detachably supported by the first shaft and the second shaft. The small-diameter support is able to support a small-diameter cylindrical substrate having a second diameter smaller than the first diameter. The small-diameter support includes a body, a first shaft, a second shaft, a first rotary roller, and a second rotary roller. The body includes a first supported portion to be supported by the first shaft, and a second supported portion to be supported by the second shaft. The first shaft is supported by the body and extends in the first direction. The second shaft is supported by the body, extends in the first direction, and is arranged side by side with the first shaft so as to be spaced from the first shaft at a second interval in the second direction. The second interval is shorter than the first interval. The second shaft is able to, together with the first shaft, support the small-diameter cylindrical substrate. The first rotary roller is supported by the first shaft so as to be rotatable relative to the body and is movable to contact with a peripheral surface of the small-diameter cylindrical substrate and rotate in accordance with rotation of the first shaft. The second rotary roller is supported by the second shaft so as to be rotatable relative to the body and is movable to contact with the peripheral surface of the small-diameter cylindrical substrate and rotate in accordance with rotation of the second shaft.

When printing is to be effected on a peripheral surface of the large-diameter cylindrical substrate having a relatively large diameter, the above-described example embodiment involves placing at least a portion of the large-diameter cylindrical substrate between the first shaft and the second shaft, with the small-diameter support detached from the first shaft and the second shaft, such that the large-diameter cylindrical substrate is supported by the first shaft and the second shaft. Rotating at least one of the first shaft and the second shaft enables rotation of the large-diameter cylindrical substrate. When printing is to be effected on the peripheral surface of the small-diameter cylindrical substrate having a relatively small diameter, the above-described example embodiment involves causing the small-diameter support to be supported by the first shaft and the second shaft, and placing the small-diameter cylindrical substrate between the first and second shafts of the small-diameter support so as to bring the first and second rotary rollers into contact with the peripheral surface of the small-diameter cylindrical substrate such that the small-diameter cylindrical substrate is supported by the first and second rotary rollers. Rotating at least one of the first shaft and the second shaft results in rotation of at least one of the first shaft and the second shaft and rotation of at least one of the first rotary roller and the second rotary roller. This enables rotation of the small-diameter cylindrical substrate. Accordingly, the above-described example embodiment enables printing on the peripheral surfaces of the cylindrical substrates different in diameter while rotating the cylindrical substrates, without adjusting the interval between the first shaft and the second shaft. Specifically, the above-described example embodiment enables printing on the peripheral surface of the large-diameter cylindrical substrate while rotating the large-diameter cylindrical substrate, with no small-diameter support supported by the first shaft and the second shaft, and enables printing on the peripheral surface of the small-diameter cylindrical substrate while rotating the small-diameter cylindrical substrate, with the small-diameter support supported by the first shaft and the second shaft. Consequently, the above-described example embodiment makes it unnecessary to adjust the interval between the first shaft and the second shaft and is thus able to avoid complicated control.

Various example embodiments of the present invention provide printing jigs each of which is able to avoid complicated control when printing is to be effected on peripheral surfaces of cylindrical substrates which are different in diameter and at least portions of which have cylindrical outer peripheral shapes, and printers including the printing jigs.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view of a printer according to a first example embodiment of the present invention.

FIG. 2 is a perspective view of an inner structure of the printer according to the first example embodiment, with a substrate supported by a supporting table.

FIG. 3 is a perspective view of a printing jig according to the first example embodiment, which is supported by the supporting table, with the printing jig supporting a large-diameter cylindrical substrate.

FIG. 4 is a plan view of the printing jig according to the first example embodiment, which is supported by the supporting table, with the printing jig supporting the large-diameter cylindrical substrate.

FIG. 5 is a cross-sectional view of the printing jig taken along the line V-V in FIG. 4.

FIG. 6 is a perspective view of the printing jig according to the first example embodiment, which is supported by the supporting table, with the printing jig supporting a small-diameter cylindrical substrate.

FIG. 7 is a plan view of the printing jig according to the first example embodiment, which is supported by the supporting table, with the printing jig supporting the small-diameter cylindrical substrate.

FIG. 8 is a cross-sectional view of the printing jig taken along the line VIII-VIII in FIG. 7.

FIG. 9 is a perspective view of a small-diameter support of the printing jig according to the first example embodiment.

FIG. 10 is a plan view of the small-diameter support of the printing jig according to the first example embodiment.

FIG. 11 is a left side view of the small-diameter support of the printing jig according to the first example embodiment.

FIG. 12 is a perspective view of a printing jig according to a second example embodiment of the present invention.

FIG. 13 is a cross-sectional view of the printing jig according to the second example embodiment as viewed from right, with first and second shafts supporting a small-diameter support.

FIG. 14 is a plan view of the printing jig according to the second example embodiment.

FIG. 15 is a perspective view of the small-diameter support of the printing jig according to the second example embodiment.

FIG. 16 is a right side view of the small-diameter support of the printing jig according to the second example embodiment, with the small-diameter support supported by the first and second shafts.

FIG. 17 is a right side view of the small-diameter support of the printing jig according to the second example embodiment, illustrating first and second insertion holes.

FIG. 18 is a right side view of the small-diameter support of the printing jig according to the second example embodiment, with first and second shafts respectively disposed at lowermost positions in the first and second insertion holes.

### DETAILED DESCRIPTION OF THE EXAMPLE EMBODIMENTS

Example embodiments of the present invention will be described below with reference to the drawings. The example embodiments described below are naturally not intended to limit the present invention in any way. Components and elements having the same functions will be identified by the same reference signs and will be described briefly or will not be described when deemed redundant.

### First Example Embodiment

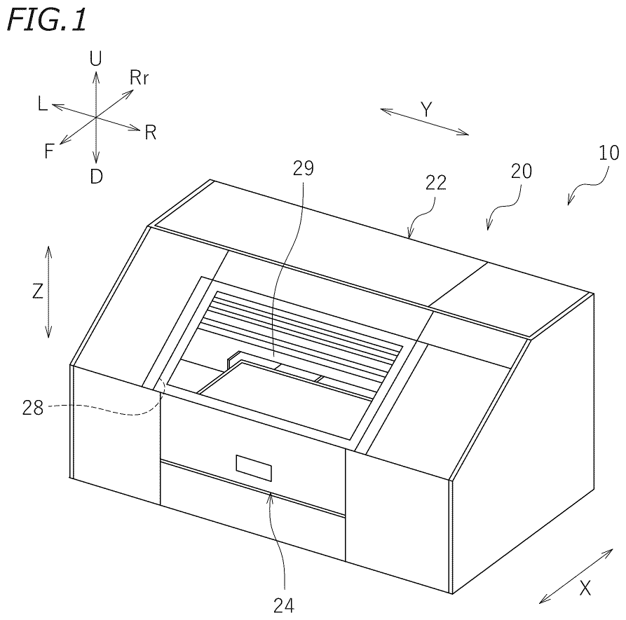

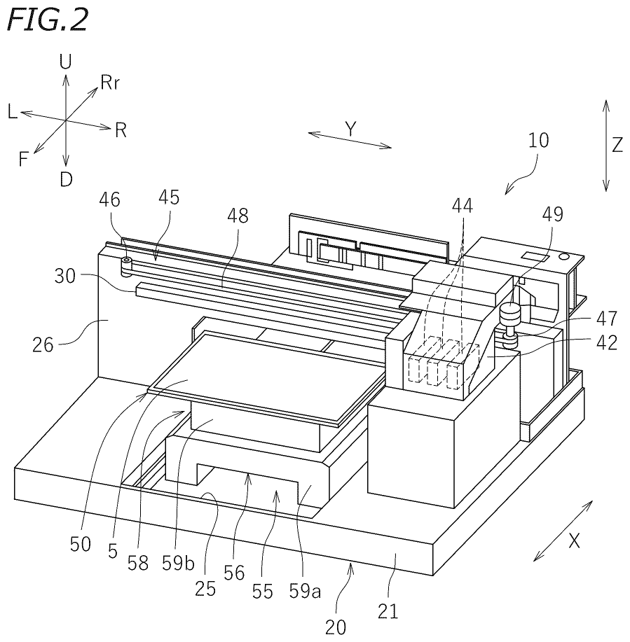

First, a printer 10 according to a first example embodiment of the present invention will be described. FIG. 1 is a perspective view of the printer 10 according to the present example embodiment. FIG. 2 is a perspective view of an inner structure of the printer 10 according to the present example embodiment. The reference signs F, Rr, L, R, U, and D in the drawings respectively represent forward, rearward, leftward, rightward, upward, and downward directions with respect to the printer 10. The reference signs X, Y, and Z respectively represent a sub-scanning direction, a main scanning direction, and a height direction. The main scanning direction Y corresponds to, for example, a right-left direction. The sub-scanning direction X intersects with the main scanning direction Y in a plan view. In this example embodiment, the sub-scanning direction X is perpendicular or substantially perpendicular to the main scanning direction Y in the plan view. The sub-scanning direction X corresponds to, for example, a front-rear direction. The height direction Z may also be referred to as an “up-down direction Z”. In the present example embodiment, the main scanning direction Y is an example of a first direction. The sub-scanning direction X is an example of a second direction intersecting with the first direction. These directions, however, are defined merely for the sake of convenience of description and do not limit in any way how the printer 10 may be installed.

In the present example embodiment, the printer 10 is an inkjet printer that effects printing in an inkjet mode. The printer 10, however, may effect printing in any mode other than an inkjet mode. The printer 10 may be, for example, a dot-impact printer, a laser printer, or a thermal printer.

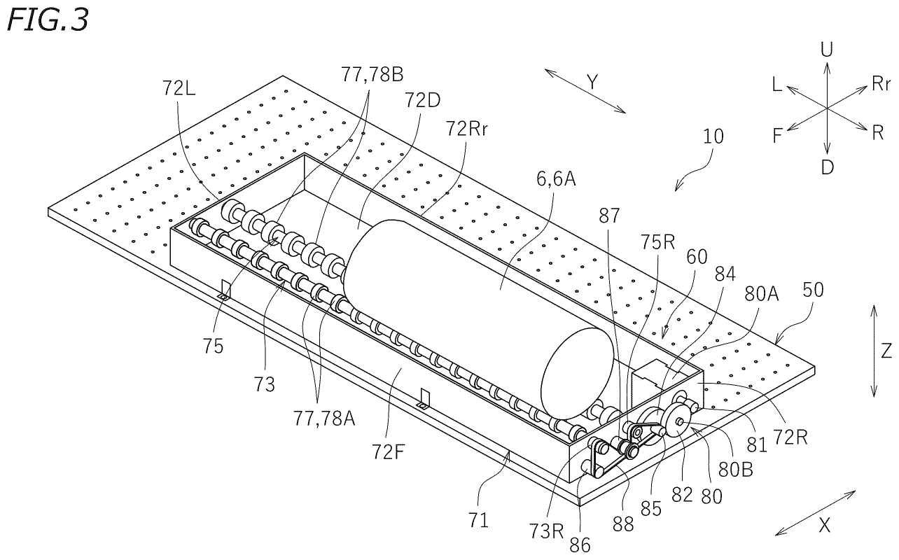

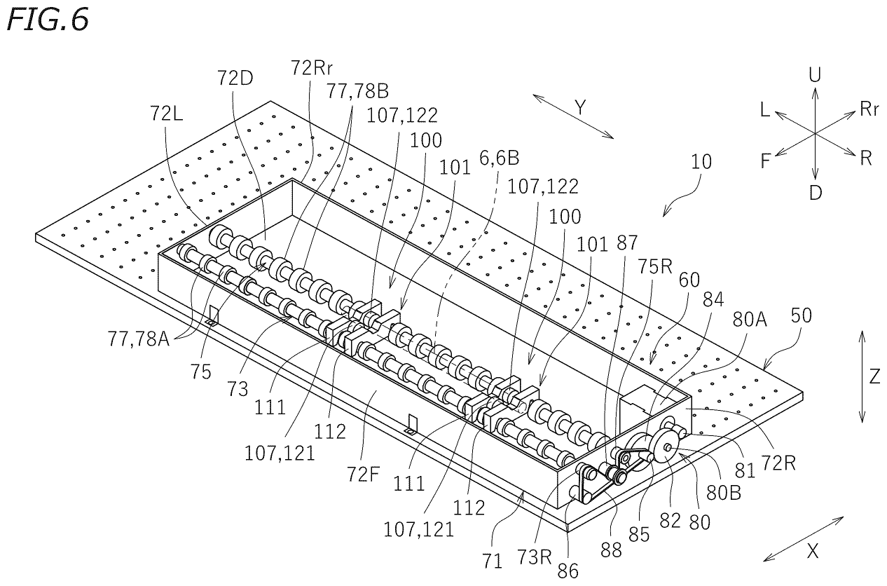

The printer 10 according to the present example embodiment is able to effect printing on a substrate 5 (see FIG. 2) supported by a supporting table 50 (see FIG. 2), which will be described below. The printer 10 is also able to effect printing on a surface (or a peripheral surface) of a cylindrical substrate 6 (see FIGS. 3 and 6) with the use of a printing jig 60 (see FIG. 3), which will be described below. In FIG. 2, the substrate 5 is illustrated as being supported by the supporting table 50. At least a portion of the substrate 5 illustrated in FIG. 2 includes a flat surface extending in the main scanning direction Y and the sub-scanning direction X. The printer 10 effects printing on the flat surface. The substrate 5 is, for example, recording paper. The substrate 5, however, may be any type of substrate other than recording paper. Examples of the substrate 5 include: sheets made of resin materials, such as polyvinyl chloride (PVC) and polyester; and relatively thick plates, such as a metallic plate, a glass plate, and a wood plate. The substrate 5 may be a three-dimensional object, examples of which include a smartphone case.

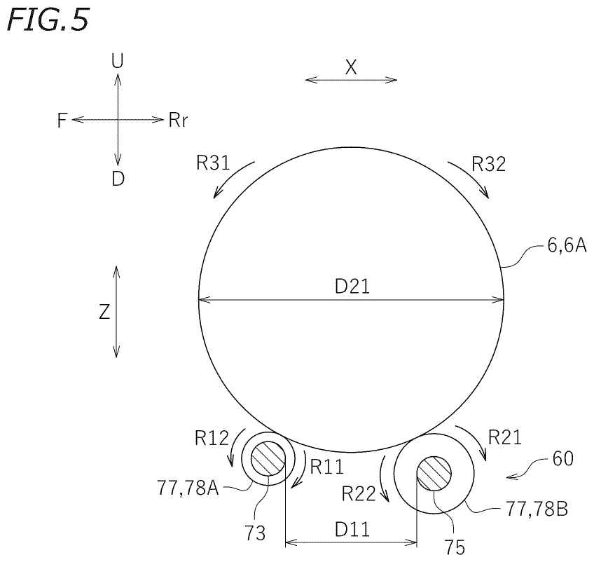

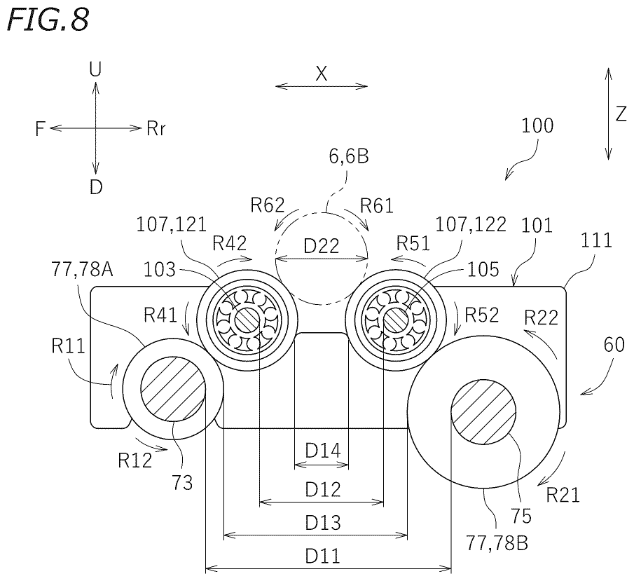

The cylindrical substrate 6 illustrated in FIGS. 3 and 6 is a three-dimensional object at least a portion of which has a cylindrical outer peripheral shape. As used herein, the phrase “portion of the cylindrical substrate 6 that has a cylindrical outer peripheral shape” refers to a portion of the cylindrical substrate 6 that comes into contact with the printing jig 60 or more specifically, large-diameter rollers 77 (see FIG. 5) or rotary rollers 107 (see FIG. 8), which will be described below. In the present example embodiment, an outermost portion of the cylindrical substrate 6 has a cylindrical outer peripheral shape. Examples of the cylindrical substrate 6 include a three-dimensional object including an internal space, such as a hollow cylindrical three-dimensional object. The cylindrical substrate 6 may be of any type, such as a bottle, a glass or a cup. Any material may be used for the cylindrical substrate 6. The cylindrical substrate 6 may be made of glass, resin, or wood.

As illustrated in FIG. 1, the printer 10 includes a printer body 20. The printer body 20 includes a base 21 (see FIG. 2), a case 22, and a cover 24. As illustrated in FIG. 2, the base 21 is a plate and defines the bottom of the printer body 20. The base 21 may have any suitable shape. In the present example embodiment, the base 21 has a quadrangular shape in a plan view. A portion of the base 21 located centrally in the main scanning direction Y is provided with an installation hole 25 for installation of the supporting table 50. The installation hole 25 has a rectangular shape longer in the sub-scanning direction X than in the main scanning direction Y.

In the present example embodiment, the printer body 20 includes an inner wall 26 rising from the base 21. The inner wall 26 extends in the main scanning direction Y and the height direction Z. The inner wall 26 is provided with an opening (not illustrated) extending through the inner wall 26 in the sub-scanning direction X. The supporting table 50 is configured to be able to pass through the opening of the inner wall 26 in moving in the sub-scanning direction X.

The case 22 illustrated in FIG. 1 is disposed on the base 21 and supported by the base 21. In this example embodiment, the printer 10 includes a space surrounded by the case 22 and the base 21 and effects printing in this space. In the present example embodiment, the inner wall 26 (see FIG. 2) is disposed in the space surrounded by the case 22 and the base 21. As illustrated in FIG. 1, the case 22 is provided at its front portion with an opening 28.

The cover 24 is supported by the case 22 such that the opening 28 is coverable and uncoverable. The cover 24 is configured to be rotatable, for example, around its rear end. The cover 24 is provided at its front portion with a window 29. The window 29 is a transparent or semitransparent structure, such as an acrylic plate. Through the window 29, a user is allowed to visually check an internal space surrounded by the case 22 and the base 21.

The following description discusses the inner structure of the printer 10. As illustrated in FIG. 2, the printer 10 includes a guide rail 30, a carriage 42, ink heads 44, a head conveyor 45, the supporting table 50, a supporting table conveyor 55, and a raising and lowering unit 58 (elevator). The guide rail 30 extends in the main scanning direction Y. In this example embodiment, the guide rail 30 is supported by a front surface of the inner wall 26 and disposed above the supporting table 50.

The carriage 42 is in slidable engagement with the guide rail 30. The carriage 42 is configured to be movable in the main scanning direction Y along the guide rail 30. The ink heads 44 are provided in the carriage 42 such that bottom surfaces of the ink heads 44 are exposed downward. The carriage 42 may be provided with any suitable number of ink heads 44. In the present example embodiment, the number of ink heads 44 provided in the carriage 42 is three. The three ink heads 44 are arranged side by side in the main scanning direction Y. Although not illustrated, bottom surfaces of the ink heads 44 are each provided with nozzles to discharge ink.

In this example embodiment, the ink to be discharged from the ink heads 44 is “ultraviolet-curable ink”. Ultraviolet-curable ink is a type of ink whose curing is promoted by exposure to ultraviolet light. Although not illustrated, the carriage 42 may be provided with an ultraviolet light applicator to apply ultraviolet light to the ink discharged onto the substrate 5 or the cylindrical substrate 6 from the ink heads 44. The ultraviolet light applicator is provided, for example, leftward or rightward of the ink heads 44. Curing of the ink discharged from the ink heads 44 is thus promoted by the ultraviolet light applied from the ultraviolet light applicator.

The head conveyor 45 moves the carriage 42 and the ink heads 44 in the main scanning direction Y. The head conveyor 45 is not limited to any particular configuration, structure, or arrangement. In the present example embodiment, the head conveyor 45 includes a left pulley 46, a right pulley 47, an endless belt 48, and a head motor 49. The left pulley 46 is provided around a left end portion of the guide rail 30. The right pulley 47 is provided around a right end portion of the guide rail 30. The belt 48 is wound around the left pulley 46 and the right pulley 47. The carriage 42 is secured to the belt 48. The head motor 49 is connected to, for example, the right pulley 47. In this example embodiment, driving the head motor 49 rotates the right pulley 47, which causes the belt 48 to run between the left pulley 46 and the right pulley 47. The running of the belt 48 moves the carriage 42 and the ink heads 44 in the main scanning direction Y.

The supporting table 50 selectively supports the substrate 5 or the printing jig 60 (see FIG. 3). In this example embodiment, when printing is to be effected on the substrate 5, the substrate 5 is placed on the supporting table 50 such that the substrate 5 undergoes printing on the supporting table 50 as illustrated in FIG. 2. An upper surface of the supporting table 50, which selectively supports the substrate 5 or the printing jig 60, extends in the main scanning direction Y and the sub-scanning direction X. The supporting table 50 is disposed below the guide rail 30, the carriage 42, and the ink heads 44. In this example embodiment, the supporting table 50 is installed with the use of the installation hole 25 defined in the base 21. The supporting table 50 is configured to be movable in the sub-scanning direction X by the supporting table conveyor 55.

As previously mentioned, the supporting table conveyor 55 moves the supporting table 50 in the sub-scanning direction X (which corresponds to the front-rear direction in this example embodiment). The supporting table conveyor 55 is not limited to any particular configuration, structure, or arrangement. In this example embodiment, the supporting table conveyor 55 includes a supporting table carriage 56 supporting the supporting table 50, and a pair of right and left slide rails (not illustrated) extending in the sub-scanning direction X and supporting the supporting table carriage 56 such that the supporting table carriage 56 is slidable along the slide rails. Although not illustrated, the supporting table conveyor 55 further includes a pair of front and rear pulleys provided forward and rearward of the slide rails, and a belt wound around the pair of front and rear pulleys. The supporting table carriage 56 is secured to this belt. A feed motor is connected to one of the pair of front and rear pulleys. In this example embodiment, driving the feed motor causes the belt to run, with the result that the supporting table 50 moves in the sub-scanning direction X together with the supporting table carriage 56.

The raising and lowering unit 58 raises and lowers the supporting table 50. In this example embodiment, the supporting table 50 is configured to be raisable and lowerable. The raising and lowering unit 58 is not limited to any particular configuration, structure, or arrangement. In the present example embodiment, the raising and lowering unit 58 includes a lower member 59a, an upper member 59b, and a raising and lowering motor (not illustrated). The upper member 59b is insertable into the lower member 59a and slidable upward and downward relative to the lower member 59a. The supporting table 50 is provided on an upper surface of the upper member 59b. The raising and lowering motor is connected to, for example, the upper member 59b. In this example embodiment, driving the raising and lowering motor raises and/or lowers the upper member 59b relative to the lower member 59a. The supporting table 50 is configured to be raised and/or lowered in accordance with the raising and/or lowering of the upper member 59b.

In the present example embodiment, when printing is to be effected on the substrate 5, the substrate 5 is supported by the supporting table 50 as illustrated in FIG. 2. Then, during movement of the ink heads 44 in the main scanning direction Y, which is caused by actuation of the head conveyor 45, ink is discharged onto the substrate 5 from the ink heads 44 so as to effect printing for a single line. After printing has been effected for the single line, the supporting table 50 supporting the substrate 5 is moved by a predetermined distance in the sub-scanning direction X by the supporting table conveyor 55. The ink heads 44 are then moved in the main scanning direction Y so as to effect printing for a next single line. Repeating single-line printing and movement of the supporting table 50 in the sub-scanning direction X alternately in this manner enables printing on the substrate 5.

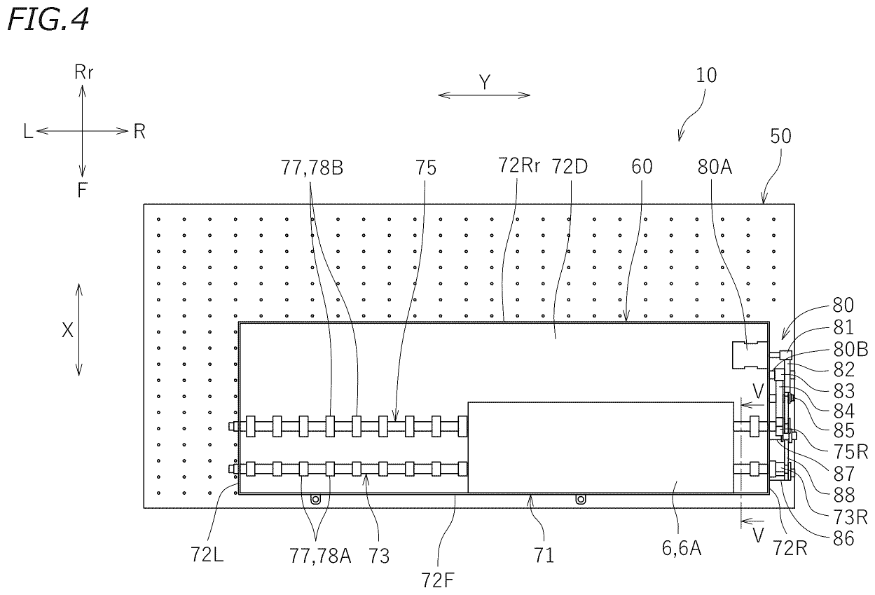

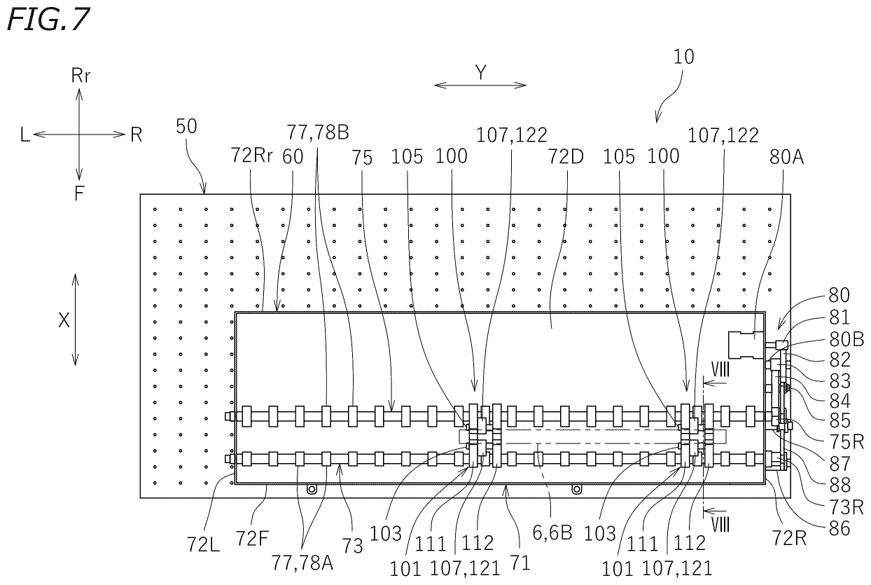

FIGS. 3 and 6 are perspective views of the printing jig 60 supported by the supporting table 50. FIGS. 4 and 7 are plan views of the printing jig 60 supported by the supporting table 50. FIG. 5 is a cross-sectional view of the printing jig 60 taken along the line V-V in FIG. 4. FIG. 8 is a cross-sectional view of the printing jig 60 taken along the line VIII-VIII in FIG. 7. As previously mentioned, the printer 10 according to the present example embodiment is able to effect printing not only on the substrate 5 but also on the cylindrical substrate 6, at least a portion of which has a cylindrical outer peripheral shape, as illustrated in FIGS. 3 and 6.

In the present example embodiment, the printer 10 includes the printing jig 60. The printing jig 60 is usable to print on the cylindrical substrate 6, which involves rotating the cylindrical substrate 6. The printing jig 60 supports the cylindrical substrate 6. The printing jig 60 is supported by the supporting table 50. In this example embodiment, the printing jig 60 is placed on the upper surface of the supporting table 50. The printing jig 60 is attachable to and detachable from the supporting table 50.

The printing jig 60 is configured to be movable in the sub-scanning direction X and the height direction Z in accordance with movement of the supporting table 50. When printing is to be effected on the cylindrical substrate 6, the printing jig 60 is fixedly attached to the supporting table 50. When printing is to be effected on the substrate 5, the printing jig 60 is detached from the supporting table 50.

As illustrated in FIG. 3, the printing jig 60 includes a jig body 71, a first shaft 73, a second shaft 75, the large-diameter rollers 77, a rotator 80, and small-diameter supports 100 (see FIG. 6). As illustrated in FIG. 3, the jig body 71 is directly supported by the supporting table 50. In this example embodiment, the jig body 71 is placed on the upper surface of the supporting table 50. The jig body 71 has a box shape with an opening facing upward.

In the present example embodiment, the jig body 71 includes a bottom plate 72D, a front plate 72F, a rear plate 72Rr, a left plate 72L, and a right plate 72R. The bottom plate 72D overlaps with the upper surface of the supporting table 50 and extends in the main scanning direction Y and the sub-scanning direction X. The front plate 72F extends upward from a front end of the bottom plate 72D. The rear plate 72Rr extends upward from a rear end of the bottom plate 72D. The left plate 72L extends upward from a left end of the bottom plate 72D and is connected to left ends of the front plate 72F and the rear plate 72Rr. The right plate 72R extends upward from a right end of the bottom plate 72D and is connected to right ends of the front plate 72F and the rear plate 72Rr.

The jig body 71 may have any suitable size. In this example embodiment, the size of the jig body 71 is such that an entirety of the jig body 71 overlaps with the supporting table 50 in a plan view as illustrated in FIG. 4. The size of the jig body 71 is such that the jig body 71 does not project out of the supporting table 50 in the plan view.

The first shaft 73 and the second shaft 75 each extend in the main scanning direction Y. The first shaft 73 and the second shaft 75 are each provided at a front portion of the jig body 71. The first shaft 73 and the second shaft 75 are each rotatably supported by the jig body 71. In this example embodiment, the first shaft 73 and the second shaft 75 are each located between the left plate 72L and the right plate 72R of the jig body 71. Left end portions of the first shaft 73 and the second shaft 75 are each rotatably supported by the left plate 72L. Right end portions of the first shaft 73 and the second shaft 75 are each rotatably supported by the right plate 72R.

The first shaft 73 and the second shaft 75 are arranged side by side in the sub-scanning direction X. In this example embodiment, the second shaft 75 is disposed behind the first shaft 73. Alternatively, the second shaft 75 may be disposed in front of the first shaft 73. As illustrated in FIG. 5, an interval between the first shaft 73 and the second shaft 75 is a first interval D11. The first interval D11 is a distance between the first shaft 73 and the second shaft 75 in the sub-scanning direction X.

In the present example embodiment, the printing jig 60 is able to support the cylindrical substrate 6 (see FIG. 5) that has a first diameter D21, and the cylindrical substrate 6 (see FIG. 8) that has a second diameter D22. The second diameter D22 is smaller than the first diameter D21. The cylindrical substrate 6 that has the first diameter D21 as illustrated in FIG. 5 will be referred to as a “large-diameter cylindrical substrate 6A”. The cylindrical substrate 6 that has the second diameter D22 as illustrated in FIG. 8 will be referred to as a “small-diameter cylindrical substrate 6B”. As illustrated in FIG. 5, the first diameter D21 of the large-diameter cylindrical substrate 6A is greater than the first interval D11 between the first shaft 73 and the second shaft 75. The large-diameter cylindrical substrate 6A is thus supported by the first shaft 73 and the second shaft 75. As illustrated in FIG. 8, the second diameter D22 of the small-diameter cylindrical substrate 6B is shorter than the first interval D11. The second diameter D22 of the small-diameter cylindrical substrate 6B is smaller than an interval D13 between each first large-diameter roller 78A and an associated second large-diameter roller 78B, which will be described below. The first shaft 73 and the second shaft 75 are thus unable to directly support the small-diameter cylindrical substrate 6B, with the result that when no small-diameter support 100 is used to support the small-diameter cylindrical substrate 6B, the small-diameter cylindrical substrate 6B will pass between the first shaft 73 and the second shaft 75. How the small-diameter cylindrical substrate 6B is supported by the small-diameter supports 100 will be described below.

In effecting printing on the large-diameter cylindrical substrate 6A while rotating the large-diameter cylindrical substrate 6A, the present example embodiment involves, as illustrated in FIG. 4, placing at least a portion of the large-diameter cylindrical substrate 6A between the first shaft 73 and the second shaft 75 such that a central axis of the large-diameter cylindrical substrate 6A extends in the main scanning direction Y. This allows a front portion of the large-diameter cylindrical substrate 6A to be supported by the first shaft 73 and allows a rear portion of the large-diameter cylindrical substrate 6A to be supported by the second shaft 75 as illustrated in FIG. 5.

As illustrated in FIG. 3, the large-diameter rollers 77 are fitted to the first shaft 73 and the second shaft 75. Each large-diameter roller 77 fitted to the first shaft 73 may also be referred to as the “first large-diameter roller 78A”. Each large-diameter roller 77 fitted to the second shaft 75 may also be referred to as the “second large-diameter roller 78B”. The first large-diameter rollers 78A rotate together with the first shaft 73. The second large-diameter rollers 78B rotate together with the second shaft 75. As illustrated in FIG. 5, the first large-diameter rollers 78A and the second large-diameter rollers 78B come into direct contact with the large-diameter cylindrical substrate 6A. In this example embodiment, the first shaft 73 and the second shaft 75 indirectly support the large-diameter cylindrical substrate 6A through the large-diameter rollers 77.

The printing jig 60 may include any suitable number of first large-diameter rollers 78A and any suitable number of second large-diameter rollers 78B. In this example embodiment, the printing jig 60 includes more than one first large-diameter roller 78A and more than one second large-diameter roller 78B. In this example embodiment, the first large-diameter rollers 78A and the second large-diameter rollers 78B are equal in number. Alternatively, the first large-diameter rollers 78A and the second large-diameter rollers 78B may differ in number. The first large-diameter rollers 78A and the second large-diameter rollers 78B are respectively detachable from the first shaft 73 and the second shaft 75. The number of first large-diameter rollers 78A and the number of second large-diameter rollers 78B are changeable when necessary. Intervals between the first large-diameter rollers 78A and intervals between the second large-diameter rollers 78B are also changeable when necessary. Any suitable material may be used for the large-diameter rollers 77. In this example embodiment, the large-diameter rollers 77 are elastic bodies. The large-diameter rollers 77 are made of, for example, rubber. This makes the large-diameter cylindrical substrate 6A less prone to slip over the first shaft 73 and the second shaft 75.

In the present example embodiment, the first large-diameter rollers 78A are smaller in outer diameter than the second large-diameter rollers 78B. In this example embodiment, the first shaft 73 is disposed higher than the second shaft 75 in order to make an upper end of each first large-diameter roller 78A level with an upper end of the associated second large-diameter roller 78B as illustrated in FIG. 5. The first large-diameter rollers 78A may be equal in outer diameter to the second large-diameter rollers 78B. The first large-diameter rollers 78A may be larger in outer diameter than the second large-diameter rollers 78B. For example, when the first large-diameter rollers 78A and the second large-diameter rollers 78B are equal in outer diameter, the first shaft 73 and the second shaft 75 may be level with each other.

As illustrated in FIG. 3, the rotator 80 is provided on the jig body 71. In this example embodiment, the rotator 80 is provided on the right plate 72R of the jig body 71. The rotator 80 is rotatable the first shaft 73 and the second shaft 75. The rotator 80 is rotatable the cylindrical substrate 6 by rotating the first shaft 73 and the second shaft 75. The rotator 80 is not limited to any particular configuration, structure, or arrangement. In the present example embodiment, the rotator 80 includes a rotary motor 80A, a first gear 81, a second gear 82, a third gear 83 (see FIG. 4), a fourth gear 84, a supporting shaft 85, a first idler pulley 86, a second idler pulley 87, and a conveying belt 88.

The rotary motor 80A is disposed, for example, inside the jig body 71. In this example embodiment, the rotary motor 80A is disposed on the left of a rear portion of the right plate 72R. The rotary motor 80A is disposed rearward of the second shaft 75. The first gear 81 is located outside the jig body 71. In this example embodiment, the first gear 81 is located rightward of the right plate 72R of the jig body 71 and connected to the rotary motor 80A. The second gear 82 is located in front of the first gear 81 and in mesh with the first gear 81. As illustrated in FIG. 4, the third gear 83 is located on the left of the second gear 82 and integral with the second gear 82. The second gear 82 and the third gear 83 are provided on a rotary shaft 80B extending rightward from the right plate 72R of the jig body 71. The fourth gear 84 is located in front of the third gear 83 and in mesh with the third gear 83. The supporting shaft 85 extends rightward from the right plate 72R of the jig body 71. The supporting shaft 85 is inserted through the fourth gear 84 and integral with the fourth gear 84.

The first idler pulley 86 and the second idler pulley 87 extend rightward from the right plate 72R of the jig body 71. The first idler pulley 86 is disposed forward of the supporting shaft 85. The second idler pulley 87 is disposed forward of the supporting shaft 85 and rearward of the first idler pulley 86. As illustrated in FIG. 3, the first shaft 73 is located between the first idler pulley 86 and the second idler pulley 87 and above the first idler pulley 86 and the second idler pulley 87, and the second shaft 75 is located between the second idler pulley 87 and the supporting shaft 85 and above the second idler pulley 87 and the supporting shaft 85. The conveying belt 88 is wound around the supporting shaft 85, the first idler pulley 86, a right end portion 73R of the first shaft 73, the second idler pulley 87, and a right end portion 75R of the second shaft 75.

In the present example embodiment, driving the rotary motor 80A causes the conveying belt 88 to run. The rotator 80 is configured such that the running of the conveying belt 88 rotates the first shaft 73 and the second shaft 75. As illustrated in FIG. 5, the present example embodiment involves actuating the rotator 80 such that the large-diameter cylindrical substrate 6A rotates in a direction R31 upon rotation of the first shaft 73 in a direction R11 and rotation of the second shaft 75 in a direction R21, and the large-diameter cylindrical substrate 6A rotates in a direction R32 upon rotation of the first shaft 73 in a direction R12 and rotation of the second shaft 75 in a direction R22.

In effecting printing on a peripheral surface of the large-diameter cylindrical substrate 6A, the present example embodiment involves placing the large-diameter cylindrical substrate 6A on the first and second large-diameter rollers 78A and 78B from above such that at least a portion of the large-diameter cylindrical substrate 6A is located between the first shaft 73 and the second shaft 75. The large-diameter cylindrical substrate 6A is thus supported by the first shaft 73 and the second shaft 75. In this state, during movement of the ink heads 44 (see FIG. 2) in the main scanning direction Y caused by the head conveyor 45 (see FIG. 2), ink is discharged from the ink heads 44 onto the large-diameter cylindrical substrate 6A so as to effect printing for a single line. This single-line printing is effected on an upper surface of the large-diameter cylindrical substrate 6A. After this single-line printing, the rotator 80 (see FIG. 3) of the printing jig 60 is actuated, which rotates the first shaft 73 and the second shaft 75 so as to rotate the large-diameter cylindrical substrate 6A by a predetermined rotation angle. The ink heads 44 are then moved in the main scanning direction Y so as to effect next single-line printing on the upper surface of the large-diameter cylindrical substrate 6A. Repeating single-line printing and rotation of the large-diameter cylindrical substrate 6A in this manner enables printing on the peripheral surface of the large-diameter cylindrical substrate 6A.

The present example embodiment is able to rotate the small-diameter cylindrical substrate 6B (see FIG. 8), which has the second diameter D22 (see FIG. 8) smaller than the first diameter D21 (see FIG. 5) of the large-diameter cylindrical substrate 6A as previously described, so as to effect printing on the small-diameter cylindrical substrate 6B. In this example embodiment, the small-diameter cylindrical substrate 6B is rotatable by using the small-diameter supports 100 of the printing jig 60 as illustrated in FIG. 7. The following description discusses the small-diameter supports 100.

As illustrated in FIG. 8, the small-diameter supports 100 are able to support the small-diameter cylindrical substrate 6B. The small-diameter supports 100 are attached to the first shaft 73 and the second shaft 75 of the printing jig 60 from above and thus supported by the first shaft 73 and the second shaft 75 so as to be detachable therefrom. In the present example embodiment, the small-diameter supports 100 are provided on the first shaft 73 and the second shaft 75. The small-diameter cylindrical substrate 6B is provided on the small-diameter supports 100 that are located on the first shaft 73 and the second shaft 75.

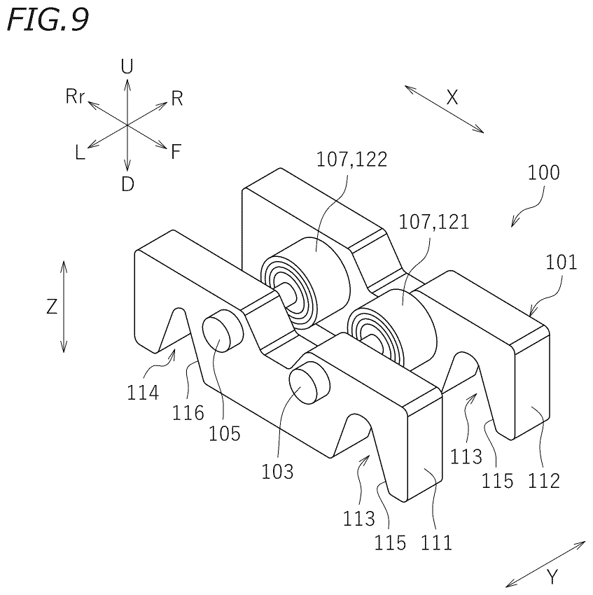

Each small-diameter support 100 is not limited to any particular configuration, structure, or arrangement. FIGS. 9, 10, and 11 are respectively a perspective view, a plan view, and a left side view of each small-diameter support 100 of the printing jig 60. In the present example embodiment, each small-diameter support 100 includes a body 101, a first shaft 103, a second shaft 105, and the rotary rollers 107 as illustrated in FIG. 9.

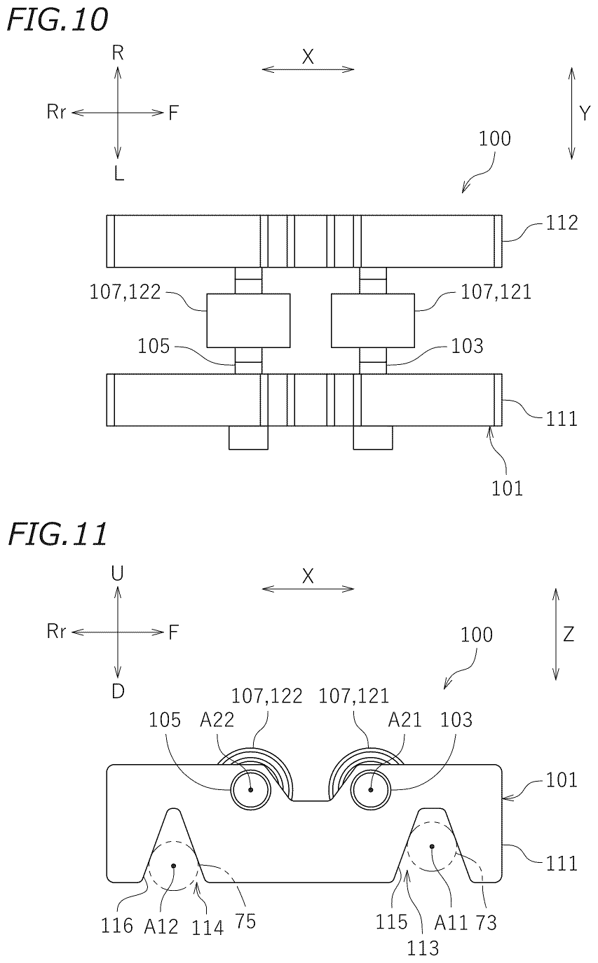

The body 101 of each small-diameter support 100 includes two body components, i.e., a first body component 111 and a second body component 112. The body 101 of each small-diameter support 100 does not necessarily have to include two body components. The body 101 of each small-diameter support 100 may include a single body component or may include three or more body components. The first and second body components 111 and 112 are plates extending in the sub-scanning direction X and the height direction Z. As illustrated in FIG. 10, the first and second body components 111 and 112 are arranged side by side in the main scanning direction Y.

As illustrated in FIG. 11, the body 101 of each small-diameter support 100 includes first supported portions 113 and second supported portions 114. The first supported portions 113 are portions of each body 101 that are to be supported by the first shaft 73. The second supported portions 114 are portions of each body 101 that are to be supported by the second shaft 75. In this example embodiment, the first and second supported portions 113 and 114 are provided on both of the first and second body components 111 and 112.

In the present example embodiment, the first supported portions 113 are provided with first recesses 115 recessed upward from lower surfaces of each body 101, which are lower surfaces of the first and second body components 111 and 112 in this example embodiment. The second supported portions 114 are provided with second recesses 116 recessed upward from the lower surfaces of each body 101, which are the lower surfaces of the first and second body components 111 and 112 in this example embodiment. In FIG. 9, the second supported portion 114 and the second recess 116 of the second body component 112 are not illustrated. As illustrated in FIG. 11, the first and second shafts 73 and 75 are respectively brought into engagement with the first and second recesses 115 and 116, with the result that the first and second supported portions 113 and 114 are respectively supported by the first and second shafts 73 and 75.

The first and second recesses 115 and 116 are arranged side by side in the sub-scanning direction X. In the present example embodiment, the first recesses 115 are greater in width (i.e., length in the sub-scanning direction X) than the second recesses 116 at the same level (i.e., at corresponding positions in the height direction Z). This is because the first shaft 73 is disposed higher than the second shaft 75 as previously mentioned. For example, when the first shaft 73 and the second shaft 75 are level with each other, the first and second recesses 115 and 116 may be equal in width at the same level.

As illustrated in FIG. 10, the first and second shafts 103 and 105 are in the form of rods supported by each body 101 and extending in the main scanning direction Y. The first and second shafts 103 and 105 are disposed in parallel or substantially in parallel with each other. The first and second shafts 103 and 105 extend between the first and second body components 111 and 112 of each body 101. First ends of the first and second shafts 103 and 105 are connected to each first body component 111. Second ends of the first and second shafts 103 and 105 are connected to each second body component 112. As illustrated in FIG. 11, the first and second shafts 103 and 105 are disposed above the first and second supported portions 113 and 114 and between the first and second supported portions 113 and 114.

The first and second shafts 103 and 105 are arranged side by side in the sub-scanning direction X. In the present example embodiment, each first shaft 103 is disposed closer to the first supported portions 113 than the associated second shaft 105. In this example embodiment, each first shaft 103 is disposed forward of the associated second shaft 105. Alternatively, each first shaft 103 may be disposed closer to the second supported portions 114 than the associated second shaft 105. In other words, each first shaft 103 may be disposed rearward of the associated second shaft 105. As illustrated in FIG. 8, an interval between each first shaft 103 and the associated second shaft 105 (i.e., a distance between each first shaft 103 and the associated second shaft 105 in the sub-scanning direction X) is a second interval D12. The second interval D12 is shorter than the first interval D11, which is the interval between the first shaft 73 and the second shaft 75. The second interval D12 is shorter than the interval D13 between each first large-diameter roller 78A and the associated second large-diameter roller 78B. In this example embodiment, the second interval D12 is greater than the second diameter D22 of the small-diameter cylindrical substrate 6B. Alternatively, the second interval D12 may be smaller than the second diameter D22 or may be equal to the second diameter D22. The present example embodiment enables the small-diameter cylindrical substrate 6B to be placed on the rotary rollers 107 (see FIG. 8) and thus supported by the first and second shafts 103 and 105.

As illustrated in FIG. 11, the present example embodiment involves placing the first and second shafts 103 and 105 at higher levels than the first shaft 73 and the second shaft 75, with the small-diameter supports 100 supported by the first shaft 73 and the second shaft 75. In other words, a central axis A21 of each first shaft 103 and a central axis A22 of each second shaft 105 are placed at higher levels than a central axis A11 of the first shaft 73 and a central axis A12 of the second shaft 75.

As illustrated in FIG. 10, the rotary rollers 107 are rotatably fitted to the first and second shafts 103 and 105. In this example embodiment, the rotary roller 107 fitted to each first shaft 103 will be referred to as a “first rotary roller 121”, and the rotary roller 107 fitted to each second shaft 105 will be referred to as a “second rotary roller 122”. The first and second rotary rollers 121 and 122 are respectively supported by the first and second shafts 103 and 105 so as to be rotatable relative to each body 101. In the present example embodiment, the first and second rotary rollers 121 and 122 are disposed between the first and second body components 111 and 112.

As illustrated in FIG. 8, the rotary rollers 107 come into direct contact with a peripheral surface of the small-diameter cylindrical substrate 6B. In this example embodiment, the first rotary rollers 121 come into direct contact with a front peripheral surface of the small-diameter cylindrical substrate 6B and thus support the small-diameter cylindrical substrate 6B. The second rotary rollers 122 come into direct contact with a rear peripheral surface of the small-diameter cylindrical substrate 6B and thus support the small-diameter cylindrical substrate 6B. The first and second shafts 103 and 105 indirectly support the small-diameter cylindrical substrate 6B through the rotary rollers 107.

In the present example embodiment, an interval D14 between the first and second rotary rollers 121 and 122 is smaller than the second diameter D22 of the small-diameter cylindrical substrate 6B. Accordingly, when the small-diameter cylindrical substrate 6B is to be supported by the first and second shafts 103 and 105, the small-diameter cylindrical substrate 6B comes into contact with the first and second rotary rollers 121 and 122 without passing between the first and second rotary rollers 121 and 122.

The rotary rollers 107 rotate together with the first shaft 73 and the second shaft 75, which are rotated by the rotator 80 (see FIG. 6). Peripheral surfaces of the rotary rollers 107 come into contact with peripheral surfaces of the large-diameter rollers 77. Upon rotation of the large-diameter rollers 77, rotational forces of the large-diameter rollers 77 are transmitted to the rotary rollers 107 so as to rotate the rotary rollers 107. The rotation of the rotary rollers 107 results in rotation of the small-diameter cylindrical substrate 6B.

In this example embodiment, the first rotary rollers 121 are rotatable in accordance with rotation of the first shaft 73, and the second rotary rollers 122 are rotatable in accordance with rotation of the second shaft 75. Specifically, peripheral surfaces of the first rotary rollers 121 come into contact with peripheral surfaces of the first large-diameter rollers 78A fitted to the first shaft 73. Peripheral surfaces of the second rotary rollers 122 come into contact with peripheral surfaces of the second large-diameter rollers 78B fitted to the second shaft 75. Rotation of the first large-diameter rollers 78A together with the first shaft 73 results in rotation of the first rotary rollers 121. Rotation of the second large-diameter rollers 78B together with the second shaft 75 results in rotation of the second rotary rollers 122. In the present example embodiment, the rotator 80 causes the first shaft 73 and the second shaft 75 to rotate simultaneously in the same direction. Accordingly, the first rotary rollers 121 and the second rotary rollers 122 also rotate simultaneously in the same direction.

As illustrated in FIG. 8, for example, rotation of the first shaft 73 and the first large-diameter rollers 78A in the direction R11 causes the first rotary rollers 121 to rotate in a direction R41, and rotation of the second shaft 75 and the second large-diameter rollers 78B in the direction R21 causes the second rotary rollers 122 to rotate in a direction R51. This results in rotation of the small-diameter cylindrical substrate 6B in a direction R61. For example, rotation of the first shaft 73 and the first large-diameter rollers 78A in the direction R12 causes the first rotary rollers 121 to rotate in a direction R42, and rotation of the second shaft 75 and the second large-diameter rollers 78B in the direction R22 causes the second rotary rollers 122 to rotate in a direction R52. This results in rotation of the small-diameter cylindrical substrate 6B in a direction R62.

Any suitable material may be used for the rotary rollers 107, i.e., the first and second rotary rollers 121 and 122. In the present example embodiment, at least the peripheral surfaces of the first and second rotary rollers 121 and 122 are made of elastic bodies (e.g., rubber). Portions of the first and second rotary rollers 121 and 122 other than the peripheral surfaces thereof may be made of elastic bodies (e.g., rubber) or may be made of materials other than elastic bodies (e.g., metal).

In the present example embodiment, the peripheral surfaces of the rotary rollers 107 are equal in hardness to or lower in hardness than the peripheral surfaces of the large-diameter rollers 77. In this example embodiment, the large-diameter rollers 77, for example, are each made of a material having a first hardness. The rotary rollers 107 (or specifically, the first rotary rollers 121 and the second rotary rollers 122) are each made of a material having a second hardness. In this example embodiment, the second hardness is equal to the first hardness or lower than the first hardness.

The above description has discussed the structure of each small-diameter support 100. The following description discusses a procedure for effecting printing on the peripheral surface of the small-diameter cylindrical substrate 6B while rotating the small-diameter cylindrical substrate 6B. In this example embodiment, the small-diameter cylindrical substrate 6B is rotated by using the two small-diameter supports 100 as illustrated in FIG. 6. One of the small-diameter supports 100 supports a first end portion of the small-diameter cylindrical substrate 6B. The other small-diameter support 100 supports a second end portion of the small-diameter cylindrical substrate 6B. The number of small-diameter supports 100 to be used to rotate the small-diameter cylindrical substrate 6B is not limited to two, but may be three or more. The number of small-diameter supports 100 is set in accordance with a length of the small-diameter cylindrical substrate 6B in its axial direction (which corresponds to the main scanning direction Y in this example embodiment).

In the present example embodiment, the procedure first involves causing the two small-diameter supports 100 to be supported by the first shaft 73 and the second shaft 75. As illustrated in FIG. 11, the procedure involves: bringing the first shaft 73 into engagement with the first recesses 115, which are included in the first supported portions 113 of the body 101 of each small-diameter support 100, with the result that the first supported portions 113 are supported by the first shaft 73, and bringing the second shaft 75 into engagement with the second recesses 116, which are included in the second supported portions 114 of the body 101 of each small-diameter support 100, with the result that the second supported portions 114 are supported by the second shaft 75. As illustrated in FIG. 8, the peripheral surface of the first rotary roller 121 of each small-diameter support 100 is brought into contact with the peripheral surface of the associated first large-diameter roller 78A fitted to the first shaft 73, and the peripheral surface of the second rotary roller 122 of each small-diameter support 100 is brought into contact with the peripheral surface of the associated second large-diameter roller 78B fitted to the second shaft 75.

In the present example embodiment, the position of each small-diameter support 100 with respect to the first shaft 73 and the second shaft 75 is suitably changeable. Accordingly, the locations of the two small-diameter supports 100 may be determined in accordance with the length of the small-diameter cylindrical substrate 6B in the main scanning direction Y.

After the two small-diameter supports 100 have been supported by the first shaft 73 and the second shaft 75 as described above, the procedure involves causing the small-diameter cylindrical substrate 6B to be supported by the two small-diameter supports 100. In this case, the small-diameter cylindrical substrate 6B is placed from above on the rotary rollers 107 fitted to the first and second shafts 103 and 105 of each small-diameter support 100 such that the small-diameter cylindrical substrate 6B is located between the first and second shafts 103 and 105 of each small-diameter support 100. The small-diameter cylindrical substrate 6B is thus brought into contact with the peripheral surfaces of the first rotary rollers 121 fitted to the first shafts 103 and brought into contact with the peripheral surfaces of the second rotary rollers 122 fitted to the second shafts 105.

In this state, during movement of the ink heads 44 in the main scanning direction Y caused by the head conveyor 45 (see FIG. 2), ink is discharged from the ink heads 44 onto the small-diameter cylindrical substrate 6B so as to effect printing for a single line. This single-line printing is effected on an upper surface of the small-diameter cylindrical substrate 6B. After this single-line printing, the small-diameter cylindrical substrate 6B is rotated by a predetermined rotation angle. In this case, actuation of the rotator 80 causes the first shaft 73 and the second shaft 75 to rotate as illustrated in FIG. 8. The first large-diameter rollers 78A rotate together with the rotation of the first shaft 73. Upon rotation of the first large-diameter rollers 78A, the first rotary rollers 121 in contact with the first large-diameter rollers 78A rotate. Similarly, the second large-diameter rollers 78B rotate together with the rotation of the second shaft 75, with the result that the second rotary rollers 122 in contact with the second large-diameter rollers 78B rotate. The rotation of the first rotary rollers 121 and the second rotary rollers 122 results in rotation of the small-diameter cylindrical substrate 6B.

After the small-diameter cylindrical substrate 6B has been rotated by the predetermined rotation angle as described above, the ink heads 44 are moved in the main scanning direction Y so as to effect next single-line printing on the upper surface of the small-diameter cylindrical substrate 6B. Repeating single-line printing and rotation of the small-diameter cylindrical substrate 6B in this manner enables printing on the peripheral surface of the small-diameter cylindrical substrate 6B.

As illustrated in FIGS. 3 and 6, the printing jig 60 according to the present example embodiment described above is attachable to and detachable from the supporting table 50 of the printer 10 and is usable to print on the cylindrical substrate 6, at least a portion of which has a cylindrical outer peripheral shape, while the cylindrical substrate 6 is rotated. As illustrated in FIG. 6, the printing jig 60 includes the jig body 71 to be supported by the supporting table 50, the first shaft 73, the second shaft 75, the rotator 80, and the small-diameter supports 100. As illustrated in FIG. 4, the first shaft 73 is supported by the jig body 71 and extends in the main scanning direction Y. The second shaft 75 is supported by the jig body 71 and is arranged side by side with the first shaft 73 so as to be spaced from the first shaft 73 at the first interval D11 (see FIG. 5) in the sub-scanning direction X. As illustrated in FIG. 5, the second shaft 75 is able to support, together with the first shaft 73, the large-diameter cylindrical substrate 6A having the first diameter D21. As illustrated in FIG. 3, the rotator 80 rotates the first shaft 73 and the second shaft 75.

As illustrated in FIG. 8, each small-diameter support 100 is detachably supported by the first shaft 73 and the second shaft 75 and is able to support the small-diameter cylindrical substrate 6B having the second diameter D22 smaller than the first diameter D21. As illustrated in FIG. 9, each small-diameter support 100 includes the body 101, the first shaft 103, the second shaft 105, the first rotary roller 121, and the second rotary roller 122. As illustrated in FIG. 11, the body 101 of each small-diameter support 100 includes: the first supported portions 113 to be supported by the first shaft 73; and the second supported portions 114 to be supported by the second shaft 75. As illustrated in FIG. 10, the first and second shafts 103 and 105 are supported by the body 101 of each small-diameter support 100 and extend in the main scanning direction Y. As illustrated in FIG. 8, each second shaft 105 is arranged side by side with the associated first shaft 103 so as to be spaced from the associated first shaft 103 at the second interval D12 (which is shorter than the first interval D11) in the sub-scanning direction X. The second shafts able to support the small-diameter cylindrical substrate 6B together with the first shafts 103. At least either the first shafts 103 or the second shafts 105 are configured to be rotatable in accordance with rotation of an associated one of the first and second shafts 73 and 75, which are rotated by the rotator 80. In this example embodiment, both of the first and second shafts 103 and 105 are configured to be rotatable in accordance with rotation of the first and second shafts 73 and 75. In the present example embodiment, each first rotary roller 121 is supported by the associated first shaft 103 so as to be rotatable relative to the associated body 101 and is brought into contact with the peripheral surface of the small-diameter cylindrical substrate 6B. Each second rotary roller 122 is supported by the associated second shaft 105 so as to be rotatable relative to the associated body 101 and is brought into contact with the peripheral surface of the small-diameter cylindrical substrate 6B.

When printing is to be effected on the peripheral surface of the large-diameter cylindrical substrate 6A having a relatively large diameter, the present example embodiment involves, as illustrated in FIG. 5, placing at least a portion of the large-diameter cylindrical substrate 6A between the first shaft 73 and the second shaft 75, with the small-diameter supports 100 detached from the first shaft 73 and the second shaft 75, such that the large-diameter cylindrical substrate 6A is supported by the first shaft 73 and the second shaft 75. Rotating at least one of the first shaft 73 and the second shaft 75 enables rotation of the large-diameter cylindrical substrate 6A.

When printing is to be effected on the peripheral surface of the small-diameter cylindrical substrate 6B having a relatively small diameter, the present example embodiment involves, as illustrated in FIG. 8, causing each small-diameter support 100 to be supported by the first shaft 73 and the second shaft 75, and placing the small-diameter cylindrical substrate 6B between the first and second shafts 103 and 105 of each small-diameter support 100 so as to bring the first and second rotary rollers 121 and 122 into contact with the peripheral surface of the small-diameter cylindrical substrate 6B, such that the small-diameter cylindrical substrate 6B is supported by the first and second rotary rollers 121 and 122. Rotating the first and second shafts 73 and 75 results in rotation of the first and second rotary rollers 121 and 122. This enables the small-diameter cylindrical substrate 6B to rotate in accordance with the rotation of the first and second rotary rollers 121 and 122. Accordingly, the present example embodiment enables printing on the peripheral surfaces of the cylindrical substrates 6A and 6B different in diameter while rotating the cylindrical substrates 6A and 6B, without adjusting the interval between the first shaft 73 and the second shaft 75. Specifically, the present example embodiment enables printing on the peripheral surface of the large-diameter cylindrical substrate 6A while rotating the large-diameter cylindrical substrate 6A, with the small-diameter supports 100 detached from the first shaft 73 and the second shaft 75, and enables printing on the peripheral surface of the small-diameter cylindrical substrate 6B while rotating the small-diameter cylindrical substrate 6B, with the small-diameter supports 100 supported by the first shaft 73 and the second shaft 75. Consequently, the present example embodiment makes it unnecessary to adjust the interval between the first shaft 73 and the second shaft 75 and is thus able to avoid complicated control.

In the present example embodiment, the rotator 80 is configured to be able to rotate the first shaft 73 and the second shaft 75 as illustrated in FIG. 3. As illustrated in FIG. 8, the first rotary rollers 121 are rotatable in accordance with rotation of the first shaft 73, and the second rotary rollers 122 are rotatable in accordance with rotation of the second shaft 75. This makes it possible to rotate the first rotary rollers 121 by using a rotational force of the first shaft 73 and rotate the second rotary rollers 122 by using a rotational force of the second shaft 75. The small-diameter cylindrical substrate 6B that has its front and rear portions respectively supported by the first and second rotary rollers 121 and 122 is rotated by rotational forces of the first and second rotary rollers 121 and 122. Consequently, the present example embodiment is able to rotate the small-diameter cylindrical substrate 6B by using rotational forces of the two rotary rollers of each small-diameter support 100, resulting in stable rotation of the e small-diameter cylindrical substrate 6B.

In the present example embodiment, the printing jig 60 includes the large-diameter rollers 77 fitted to the first shaft 73 and the second shaft 75. The peripheral surfaces of the rotary rollers 107 come into contact with the peripheral surfaces of the large-diameter rollers 77. The rotary rollers 107 are rotatable in accordance with rotation of the large-diameter rollers 77. Thus, portions of the large-diameter rollers 77 in contact with the rotary rollers 107 enable the rotational forces of the first shaft 73 and the second shaft 75 to be transmitted to the rotary rollers 107. Accordingly, a simple arrangement that involves bringing the large-diameter rollers 77 and the rotary rollers 107 into contact with each other and rotating the large-diameter rollers 77 and the rotary rollers 107 makes it possible to rotate the small-diameter cylindrical substrate 6B by using the rotational forces of the first shaft 73 and the second shaft 75.

In the present example embodiment, the peripheral surface of each large-diameter roller 77 is made of a material having the first hardness. The peripheral surface of each rotary roller 107 is made of a material having the second hardness, which is equal to the first hardness or lower than the first hardness. Put another way, the peripheral surface of each rotary roller 107 is softer than the peripheral surface of each large-diameter roller 77. Or put even another way, the peripheral surface of each rotary roller 107 is greater in frictional force than the peripheral surface of each large-diameter roller 77. The small-diameter cylindrical substrate 6B is, for example, smaller in diameter than the large-diameter cylindrical substrate 6A and lighter in weight than the large-diameter cylindrical substrate 6A. The small-diameter cylindrical substrate 6B that is relatively light in weight as just mentioned is relatively prone to slip on the rotary rollers 107. To solve this problem, the present example embodiment makes the peripheral surface of each rotary roller 107 relatively soft, making it possible to increase friction between the small-diameter cylindrical substrate 6B and the peripheral surfaces of the rotary rollers 107. Consequently, the present example embodiment makes the small-diameter cylindrical substrate 6B less prone to slip on the rotary rollers 107 during rotation of the small-diameter cylindrical substrate 6B and thus facilitates rotation of the small-diameter cylindrical substrate 6B.

In the present example embodiment, the first supported portions 113 and the second supported portions 114 of each small-diameter support 100 respectively include, as illustrated in FIG. 11, the first recesses 115 and the second recesses 116 recessed upward from the lower surfaces of the body 101 of each small-diameter support 100. The first shaft 73 and the second shaft 75 are respectively brought into engagement with the first recesses 115 and the second recesses 116. Thus, a relatively simple arrangement that involves bringing the first shaft 73 and the second shaft 75 into engagement with the first recesses 115 and the second recesses 116, respectively, enables the first supported portions 113 and the second supported portions 114 to be respectively supported by the first shaft 73 and the second shaft 75. Consequently, the present example embodiment enables the small-diameter supports 100 to be supported by the first shaft 73 and the second shaft 75 with the relatively simple arrangement.

In the present example embodiment, the body 101 of each small-diameter support 100 includes, as illustrated in FIG. 10, the first body component 111 to which the first ends of the first and second shafts 103 and 105 are connected, and the second body component 112 which is arranged side by side with the first body component 111 in the main scanning direction Y and to which the second ends of the first and second shafts 103 and 105 are connected. Thus, the first and second shafts 103 and 105 extend between the first and second body components 111 and 112. Accordingly, the present example embodiment enables the first and second shafts 103 and 105 of each small-diameter support 100 to be stably supported by the body 101.

In the present example embodiment, the printer 10 includes, as illustrated in FIG. 2, the ink heads 44 disposed above the supporting table 50 and configured to discharge ink, and the raising and lowering unit 58 to raise and lower the supporting table 50. As illustrated in FIG. 11, with the small-diameter supports 100 supported by the first shaft 73 and the second shaft 75, the central axis A21 of each first shaft 103 and the central axis A22 of each second shaft 105 are disposed at higher levels than the central axis A11 of the first shaft 73 and the central axis A12 of the second shaft 75. Thus, supporting the small-diameter cylindrical substrate 6B with the small-diameter supports 100 enables an upper end of the small-diameter cylindrical substrate 6B to be disposed at a higher level than when the small-diameter cylindrical substrate 6B is supported by the first shaft 73 and the second shaft 75 that have the interval therebetween adjusted without the use of the small-diameter supports 100. Consequently, the present example embodiment enables the upper end of the small-diameter cylindrical substrate 6B to be disposed closer to the ink heads 44 and thus makes it possible to relatively reduce a distance the supporting table 50 is raised and lowered by the raising and lowering unit 58.

### Second Example Embodiment

The following description discusses a printing jig 160 according to a second example embodiment of the present invention. In the following description on the printing jig 160 according to the second example embodiment, components and elements similar in structure or function to those of the printing jig 60 according to the first example embodiment will be identified by the same reference signs and will be described briefly or will not be described when deemed redundant.

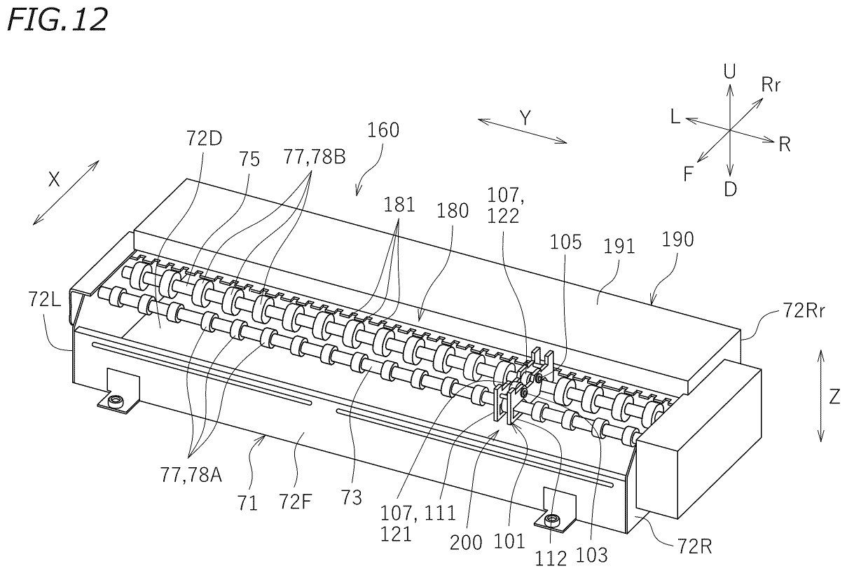

FIG. 12 is a perspective view of the printing jig 160 according to the present example embodiment. Although not illustrated, the printing jig 160 according to the present example embodiment is detachably supported by the supporting table 50 (see FIG. 3) and is usable to print on the cylindrical substrate 6 while the cylindrical substrate 6 is rotated similarly to the printing jig 60 (see FIG. 3) according to the first example embodiment. As illustrated in FIG. 12, the printing jig 160 includes a test printing stage 190 and a small-diameter support 200. The test printing stage 190 is for use in test printing, with the printing jig 160 supported by the supporting table 50. The test printing stage 190 is in the form of a plate.

The test printing stage 190 includes a test printing surface 191. The test printing surface 191 is a surface of the test printing stage 190 where test printing is to be carried out. The test printing surface 191 defines an upper surface of the test printing stage 190 and extends in the main scanning direction Y and the sub-scanning direction X. In this example embodiment, the test printing surface 191 is a rectangular surface longer in the main scanning direction Y than in the sub-scanning direction X. The test printing surface 191 supports the substrate 5 (see FIG. 2) for test printing. During test printing, the substrate 5 for test printing (which will hereinafter be referred to as a “test printing substrate 5”) is placed on the test printing surface 191. Test printing is effected on the test printing substrate 5 supported by the test printing surface 191. As used herein, the term “test printing substrate 5” refers to, for example, recording paper.

The test printing stage 190 may be positioned at any suitable location. In this example embodiment, the test printing stage 190 is provided on the jig body 71 such that the test printing surface 191 is exposed upward as illustrated in FIG. 12. In the present example embodiment, the test printing stage 190 is disposed on a rear portion of the jig body 71 and connected to an upper end of the rear plate 72Rr of the jig body 71, an upper end of a rear portion of the left plate 72L, and an upper end of a rear portion of the right plate 72R. The test printing stage 190 is disposed rearward of the first shaft 73 and the second shaft 75. Alternatively, the test printing stage 190 may be disposed forward of the first shaft 73 and the second shaft 75.

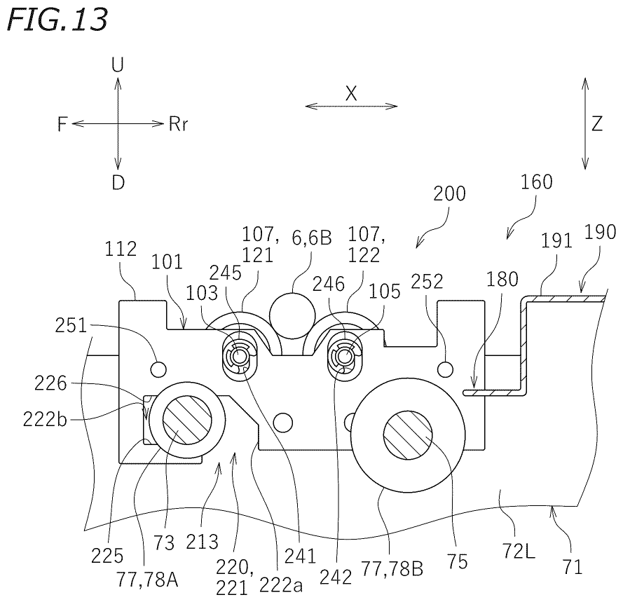

FIG. 13 is a cross-sectional view of the printing jig 160 as viewed from right, with the first and second shafts 73 and 75 supporting the small-diameter support 200. As illustrated in FIG. 13, the test printing surface 191 is disposed at the highest level among the components of the printing jig 160. In other words, the test printing surface 191 is disposed closest to the ink heads 44 (see FIG. 2). In this example embodiment, the test printing surface 191 is disposed above the first shaft 73 and the second shaft 75. The test printing surface 191 is disposed above the jig body 71. Specifically, the test printing surface 191 is disposed above the bottom plate 72D, the front plate 72F, the rear plate 72Rr, the left plate 72L, and the right plate 72R. The test printing surface 191 is disposed above the small-diameter support 200 supported by the first shaft 73 and the second shaft 75. Specifically, with the small-diameter support 200 attached to the first shaft 73 and the second shaft 75, the test printing surface 191 is disposed above an upper end of the small-diameter support 200.

The test printing surface 191 is disposed below an upper end of the small-diameter cylindrical substrate 6B supported by the small-diameter support 200. Although not illustrated, the test printing surface 191 is disposed below an upper end of the large-diameter cylindrical substrate 6A (see FIG. 5) supported by the first shaft 73 and the second shaft 75. In the present example embodiment, when printing is to be effected on the cylindrical substrate 6, the test printing surface 191 is disposed below an upper end of the cylindrical substrate 6 supported by the printing jig 160.

The test printing stage 190 may be integral with the jig body 71 or may be a component separate from and attached to the jig body 71.

Test printing to be effected on the test printing substrate 5 placed on the test printing stage 190 is carried out to inspect, for example, how ink is discharged from the nozzles (not illustrated) of the ink heads 44. As used herein, the term “test printing” may refer to test pattern printing to inspect bidirectional ink hitting positions when bidirectional printing is to be effected, or may refer to test pattern printing to check a nozzle failure in the ink heads 44. In the present example embodiment, test printing on the test printing stage 190 is carried out, for example, before printing is effected on the cylindrical substrate 6. During test printing on the test printing stage 190, the cylindrical substrate 6 (or specifically, the large-diameter cylindrical substrate 6A or the small-diameter cylindrical substrate 6B) is not supported by the printing jig 160, but the test printing substrate 5 is supported by the test printing surface 191. Test printing is carried out by discharging ink from the ink heads 44 onto the test printing substrate 5 supported by the test printing surface 191.

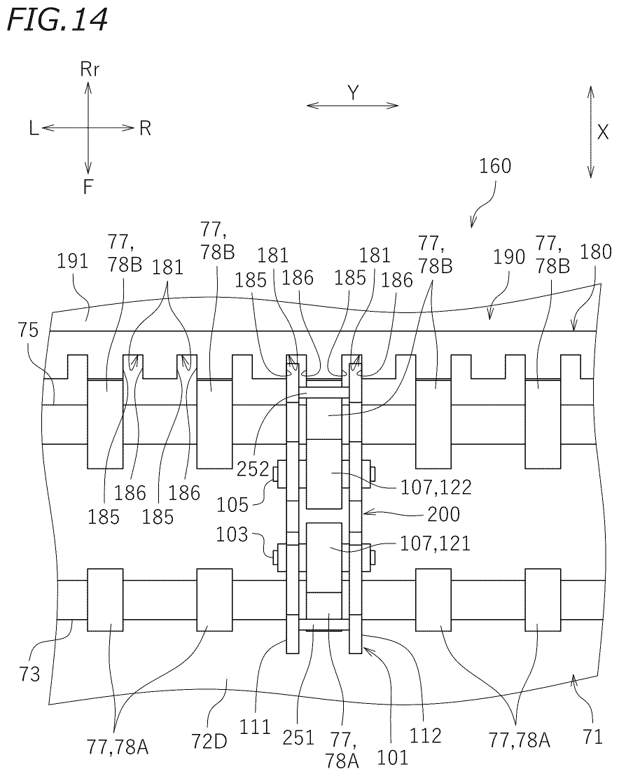

FIG. 14 is a partially enlarged plan view of the printing jig 160. In the present example embodiment, the printing jig 160 includes a restrictor 180 as illustrated FIG. 14. The restrictor 180 restricts the small-diameter support 200 supported by the first shaft 73 and the second shaft 75 from moving in the main scanning direction Y. As illustrated in FIG. 12, the restrictor 180 is provided on the jig body 71. In this example embodiment, the restrictor 180 is disposed rearward of the first shaft 73 and the second shaft 75. Alternatively, the restrictor 180 may be disposed forward of the first shaft 73 and the second shaft 75. The restrictor 180 is disposed in front of the test printing stage 190. The restrictor 180 may be integral with the test printing stage 190 or may be a component separate from the test printing stage 190.

The restrictor 180 is not limited to any particular configuration, structure, arrangement, or shape. In the present example embodiment, the restrictor 180 is in the form of a plate extending in the main scanning direction Y and the sub-scanning direction X. The restrictor 180 has a rectangular shape longer in the main scanning direction Y than in the sub-scanning direction X.

In the present example embodiment, the restrictor 180 is provided with cut-outs 181 as illustrated in FIG. 14. Portions of the body 101 of the small-diameter support 200 are inserted into the cut-outs 181. Specifically, when the small-diameter support 200 is to be supported by the first shaft 73 and the second shaft 75, rear portions of the first and second body components 111 and 112 of the body 101 are inserted into the cut-outs 181. The cut-outs 181 are recessed rearward from a front end of the restrictor 180. The cut-outs 181 include openings facing forward, and the portions of the body 101 of the small-diameter support 200 are thus inserted into the cut-outs 181 through the openings. The cut-outs 181 include first edge portions 185 and

second edge portions 186. The first edge portions 185 define edges of the cut-outs 181 located on a first side in the main scanning direction Y. In this example embodiment, the first edge portions 185 define left edges of the cut-outs 181. The second edge portions 186 define edges of the cut-outs 181 located on a second side in the main scanning direction Y. In this example embodiment, the second edge portions 186 define right edges of the cut-outs 181. The first and second edge portions 185 and 186 extend in the sub-scanning direction X. The first and second edge portions 185 and 186 are arranged side by side and face each other in the main scanning direction Y.

The first and second edge portions 185 and 186 are spaced away from each other, such that portions of the body 101 of the small-diameter support 200 are inserted into spaces between the first and second edge portions 185 and 186. Upon insertion of the portions of the body 101 into the cut-outs 181, the first edge portions 185 are located on the first side in the main scanning direction Y relative to the portions of the body 101 inserted into the cut-outs 181 (i.e., leftward of the portions of the body 101 inserted into the cut-outs 181 in this example embodiment), and the second edge portions 186 are located on the second side in the main scanning direction Y relative to the portions of the body 101 inserted into the cut-outs 181 (i.e., rightward of the portions of the body 101 inserted into the cut-outs 181 in this example embodiment). Upon insertion of the portions of the body 101 of the small-diameter support 200 into the cut-outs 181, the portions of the body 101 may come into contact with either the first edge portions 185 or the second edge portions 186, may come into contact with both of the first edge portions 185 and the second edge portions 186, or may come into contact with neither the first edge portions 185 nor the second edge portions 186. In this example embodiment, contact of the portions of the body 101 with the first edge portions 185 restricts any further leftward movement of the small-diameter support 200 relative to the first shaft 73 and the second shaft 75, and contact of the portions of the body 101 with the second edge portions 186 restricts any further rightward movement of the small-diameter support 200 relative to the first shaft 73 and the second shaft 75.

The restrictor 180 may be provided with any suitable number of cut-outs 181. In this example embodiment, the restrictor 180 is provided with more than one cut-out 181. The cut-outs 181 are arranged side by side in the main scanning direction Y. In the present example embodiment, intervals between the cut-outs 181 adjacent to each other in the main scanning direction Y may be equal to each other. Alternatively, the intervals between the cut-outs 181 adjacent to each other in the main scanning direction Y may differ from each other. In this example embodiment, the cut-outs 181 are disposed between the large-diameter rollers 77 adjacent to each other in the main scanning direction Y (i.e., between the first large-diameter rollers 78A adjacent to each other in the main scanning direction Y or between the second large-diameter rollers 78B adjacent to each other in the main scanning direction Y). Every two of the cut-outs 181 are disposed between associated two of the large-diameter rollers 77 (which are adjacent to each other in the main scanning direction Y) in the main scanning direction Y.

In the present example embodiment, each of the large-diameter rollers 77 adjacent to each other in the main scanning direction Y is disposed between associated two of the cut-outs 181 arranged side by side in the main scanning direction Y. Upon insertion of the portions of the body 101 into the two cut-outs 181 between which the associated large-diameter roller 77 is located, the rear portion of the first body component 111 is inserted into the cut-out 181 located to the left of the associated large-diameter roller 77, and the rear portion of the second body component 112 is inserted into the cut-out 181 located to the right of the associated large-diameter roller 77.

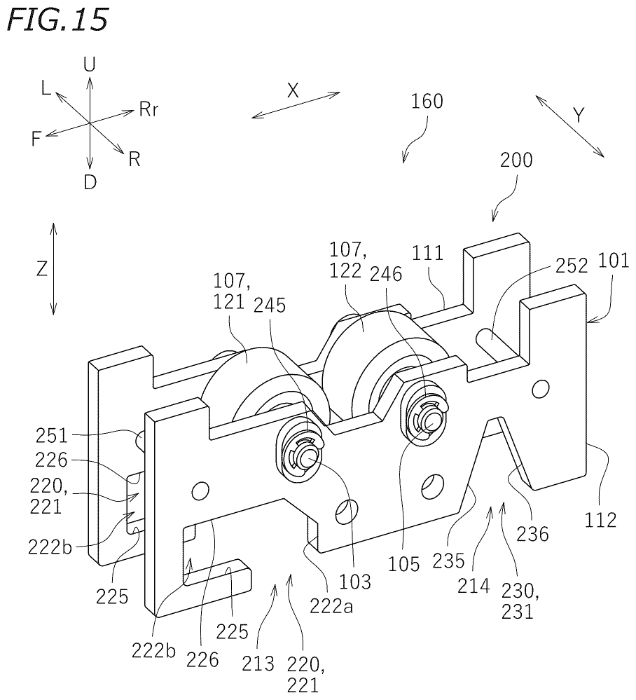

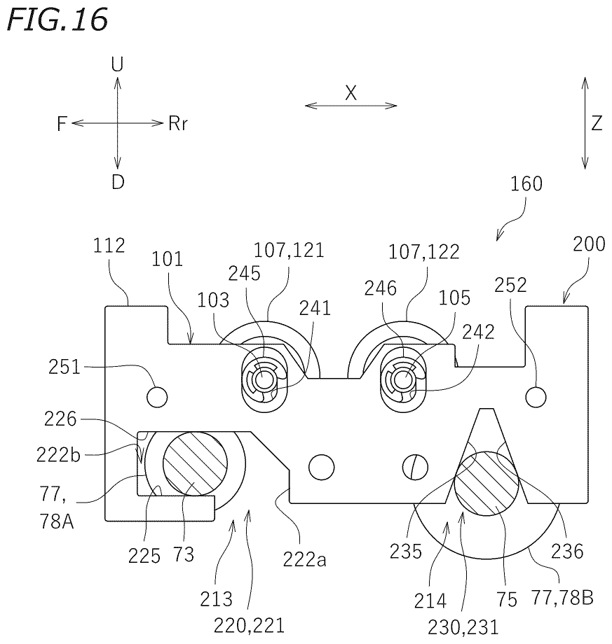

FIG. 15 is a perspective view of the small-diameter support 200 according to the present example embodiment. FIG. 16 is a right side view of the small-diameter support 200 supported by the first shaft 73 and the second shaft 75. The following description discusses the small-diameter support 200 illustrated in FIG. 15. As illustrated in FIG. 13, the small-diameter support 200 according to the present example embodiment is able to support the small-diameter cylindrical substrate 6B and is attached to the first shaft 73 and the second shaft 75 of the printing jig 160 from above and thus supported by the first shaft 73 and the second shaft 75 so as to be detachable therefrom.

s illustrated in FIG. 16, the body 101 of the small-diameter support 200 is provided with: first supported portions 213 to be supported by the first shaft 73; and second supported portions 214 to be supported by the second shaft 75. The first and second body components 111 and 112 of the body 101 are each provided with an associated one of the first supported portions 213. In this example embodiment, the first supported portions 213 include first small-diameter restrictors 220 to restrict the small-diameter support 200 supported by the first shaft 73 and the second shaft 75 from moving in the up-down direction Z. With the first supported portions 213 supported by the first shaft 73, the first small-diameter restrictors 220 restrict the small-diameter support 200 from moving in the up-down direction Z relative to the first shaft 73.

In this example embodiment, the first small-diameter restrictors 220 are provided with first restricting recesses 221. Each first restricting recess 221 includes a vertical space 222a extending in the up-down direction Z, and a horizontal space 222b continuous with the vertical space 222a and extending in the sub-scanning direction X. The vertical spaces 222a extend upward from lower ends of the body 101 (i.e., lower ends of the first and second body components 111 and 112 in this example embodiment) and include openings facing downward. The horizontal spaces 222b extend forward from upper portions of the vertical spaces 222a. The vertical spaces 222a and the horizontal spaces 222b define L-shaped spaces. In the present example embodiment, when the small-diameter support 200 is to be supported by the first shaft 73, the first shaft 73 is inserted into the first restricting recesses 221 through lower ends of the vertical spaces 222a and then moved to the horizontal spaces 222b. This causes the first shaft 73 to be caught between portions of the first small-diameter restrictors 220, which define the horizontal spaces 222b, in the up-down direction Z, with the result that the first small-diameter restrictors 220 restrict the small-diameter support 200 from moving in the up-down direction Z relative to the first shaft 73.

In the present example embodiment, the first small-diameter restrictors 220 include lower restricting edge portions 225 and upper restricting edge portions 226 as illustrated in FIG. 16. With the first shaft 73 supporting the first supported portions 213, the lower restricting edge portions 225 are disposed under the first shaft 73. In this example embodiment, the lower restricting edge portions 225 define portions of edges of the first restricting recesses 221. Specifically, the lower restricting edge portions 225 define lower edges of the horizontal spaces 222b. The lower restricting edge portions 225 extend in the sub-scanning direction X.

With the first shaft 73 supporting the first supported portions 213, the upper restricting edge portions 226 are disposed over the first shaft 73. The upper and lower restricting edge portions 226 and 225 catch the first shaft 73 therebetween. In this example embodiment, the upper restricting edge portions 226 define portions of the edges of the first restricting recesses 221. Specifically, the upper restricting edge portions 226 define upper edges of the horizontal spaces 222b. The upper restricting edge portions 226 face the lower restricting edge portions 225 in the up-down direction Z, with the horizontal spaces 222b located between the upper and lower restricting edge portions 226 and 225. The upper restricting edge portions 226 extend in the sub-scanning direction X and are in parallel or substantially in parallel with the lower restricting edge portions 225.

The first shaft 73 disposed in the horizontal spaces 222b and supporting the first supported portions 213 is in contact with the lower restricting edge portions 225 and the upper restricting edge portions 226. The first shaft 73, however, does not necessarily have to be in contact with the upper restricting edge portions 226. In this example embodiment, contact of the first shaft 73 with the lower restricting edge portions 225 restricts any further upward movement of the small-diameter support 200 relative to the first shaft 73, and contact of the first shaft 73 with the upper restricting edge portions 226 restricts any further downward movement of the small-diameter support 200 relative to the first shaft 73.

The first and second body components 111 and 112 of the body 101 are each provided with an associated one of the second supported portions 214. The second supported portions 214 include second small-diameter restrictors 230 to restrict the small-diameter support 200 supported by the first shaft 73 and the second shaft 75 from moving in the sub-scanning direction X. With the second supported portions 214 supported by the second shaft 75, the second small-diameter restrictors 230 restrict the small-diameter support 200 from moving in the sub-scanning direction X relative to the second shaft 75.

In this example embodiment, the second small-diameter restrictors 230 are provided with second restricting recesses 231. The second restricting recesses 231 extend in the up-down direction Z. In this example embodiment, the second restricting recesses 231 are recessed upward from the lower ends of the body 101 (or specifically, the lower ends of the first and second body components 111 and 112). The second restricting recesses 231 include openings facing downward. In the present example embodiment, when the small-diameter support 200 is to be supported by the second shaft 75, the second shaft 75 is inserted into the second restricting recesses 231 as illustrated in FIG. 16. This causes the second shaft 75 to be caught between portions of the second small-diameter restrictors 230, which face each other, in the sub-scanning direction X, with the result that the second small-diameter restrictors 230 restrict the small-diameter support 200 from moving in the sub-scanning direction X relative to the second shaft 75.

In the present example embodiment, the second small-diameter restrictors 230 include first restricting edge portions 235 and second restricting edge portions 236. With the second shaft 75 supporting the second supported portions 214, the first restricting edge portions 235 are disposed on a first side (i.e., front side in this example embodiment) in the sub-scanning direction X relative to the second shaft 75, and the second restricting edge portions 236 are disposed on a second side (i.e., rear side in this example embodiment) in the sub-scanning direction X relative to the second shaft 75. With the second shaft 75 supporting the second supported portions 214, the second shaft 75 is in contact with the first restricting edge portions 235 and the second restricting edge portions 236. Contact of the second shaft 75 with the first restricting edge portions 235 and the second restricting edge portions 236 restricts any further forward and rearward movement of the small-diameter support 200 relative to the second shaft 75. In this example embodiment, the first restricting edge portions 235 and the second restricting edge portions 236 respectively define front and rear edges of the second restricting recesses 231. The first restricting edge portions 235 and the second restricting edge portions 236 face each other in the sub-scanning direction X. The second shaft 75 is caught between the first restricting edge portions 235 and the second restricting edge portions 236. In this example embodiment, the second restricting recesses 231 are defined between the first restricting edge portions 235 and the second restricting edge portions 236.

In the present example embodiment, the first restricting edge portions 235 incline toward the second restricting edge portions 236 as they extend upward. The second restricting edge portions 236 incline toward the first restricting edge portions 235 as they extend upward. In this example embodiment, intervals between the first restricting edge portions 235 and the second restricting edge portions 236 narrow upward.

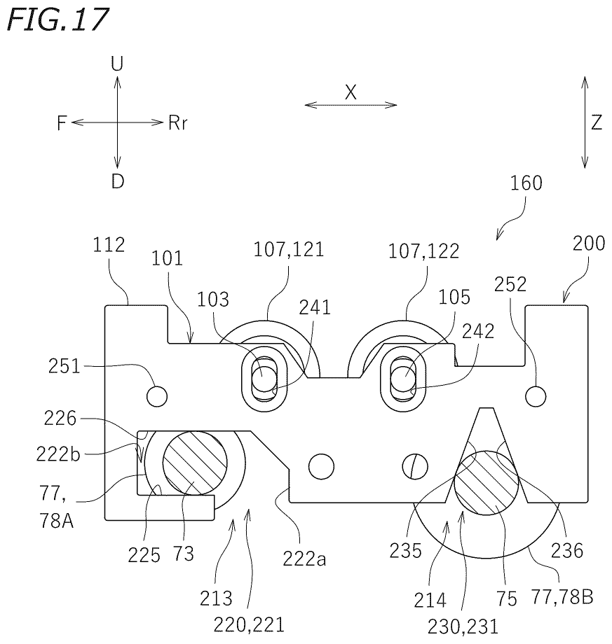

In the present example embodiment, the first shaft 103 and the second shaft 105 are supported by the body 101 of the small-diameter support 200 as illustrated in FIG. 15. In other words, the first shaft 103 and the second shaft 105 are connected to the first body component 111 and the second body component 112. FIG. 17 is a right side view of the small-diameter support 200, illustrating first and second insertion holes 241 and 242. As illustrated in FIG. 17, the body 101 is provided with the first and second insertion holes 241 and 242. The first shaft 103 is inserted through the first insertion holes 241. The second shaft 105 is inserted through the second insertion holes 242. In the present example embodiment, the first and second insertion holes 241 and 242 are defined in the first body component 111 and the second body component 112. The first shaft 103 is inserted through the first insertion holes 241 and is thus connected to the first body component 111 and the second body component 112. The second shaft 105 is inserted through the second insertion holes 242 and is thus connected to the first body component 111 and the second body component 112.

The first and second insertion holes 241 and 242 are elongated holes extending in the up-down direction Z. Thus, the first and second shafts 103 and 105 that are respectively inserted through the first and second insertion holes 241 and 242 are movable in the up-down direction Z relative to the first and second insertion holes 241 and 242, respectively. The first and second shafts 103 and 105 are respectively inserted through the first and second insertion holes 241 and 242 so as to be slidable in the up-down direction Z. In this example embodiment, the first insertion holes 241 are equal in size to the second insertion holes 242. Alternatively, the first insertion holes 241 may be different in size from the second insertion holes 242.

In the present example embodiment, the first shaft 103 is provided with a first fastener 245 (see FIG. 15) in order to make it difficult for the first shaft 103 to be detached from the first insertion holes 241. Similarly, the second shaft 105 is provided with a second fastener 246 (see FIG. 15). The shape of the first fastener 245 is such that a portion of the first fastener 245 is larger than the associated first insertion hole 241. The first fastener 245 is provided on a portion of the first shaft 103 located outside the body 101 (i.e., located opposite to the associated rotary roller 107 in this example embodiment). As illustrated in FIG. 15, the first fastener 245 is provided opposite to the associated rotary roller 107 relative to the second body component 112. The second fastener 246 is similar in shape, size, and arrangement to the first fastener 245. In FIG. 17, the first fastener 245 and the second fastener 246 are not illustrated.

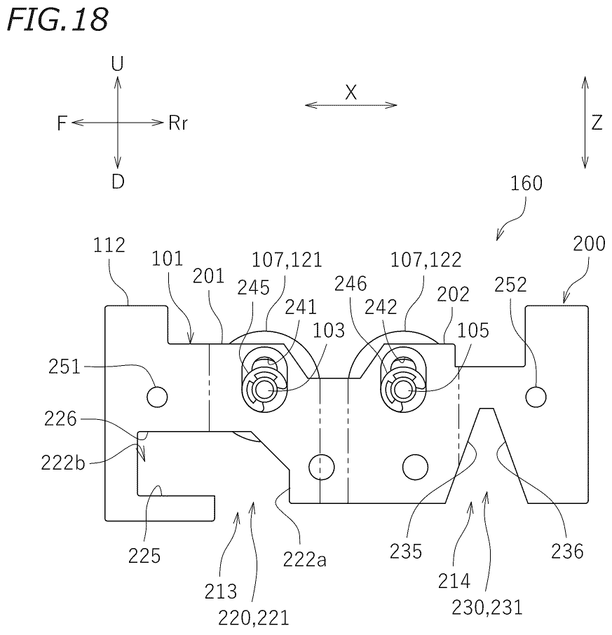

FIG. 18 is a right side view of the small-diameter support 200, with the first and second shafts 103 and 105 respectively disposed at lowermost positions in the first and second insertion holes 241 and 242. In the present example embodiment, the body 101 includes a first overlapping portion 201 and a second overlapping portion 202 as illustrated in FIG. 18. When viewed in the main scanning direction Y, the first overlapping portion 201 is a portion of the body 101 that overlaps, in the sub-scanning direction X, with the first rotary roller 121 fitted to the first shaft 103, and the second overlapping portion 202 is a portion of the body 101 that overlaps, in the sub-scanning direction X, with the second rotary roller 122 fitted to the second shaft 105. When viewed in the main scanning direction Y, a front end of the first overlapping portion 201 and a front end of the first rotary roller 121 are located at corresponding positions, and a rear end of the first overlapping portion 201 and a rear end of the first rotary roller 121 are located at corresponding positions. When viewed in the main scanning direction Y, a front end of the second overlapping portion 202 and a front end of the second rotary roller 122 are located at corresponding positions, and a rear end of the second overlapping portion 202 and a rear end of the second rotary roller 122 are located at corresponding positions.

In the present example embodiment, the first rotary roller 121 protrudes above the first overlapping portion 201, with the first shaft 103 disposed at the lowermost position relative to the first insertion holes 241 (e.g., at a position where the first shaft 103 is in contact with lower edges of the first insertion holes 241). In this case, a portion of the first rotary roller 121 (or specifically, an upper portion of the first rotary roller 121) protrudes above the first overlapping portion 201. Similarly, the second rotary roller 122 protrudes above the second overlapping portion 202, with the second shaft 105 disposed at the lowermost position relative to the second insertion holes 242. In this case, a portion of the second rotary roller 122 (or specifically, an upper portion of the second rotary roller 122) protrudes above the second overlapping portion 202.

In the present example embodiment, the small-diameter support 200 includes a first connecting rod 251 and a second connecting rod 252 as illustrated in FIG. 15. The first connecting rod 251 and the second connecting rod 252 are rods which extend in the main scanning direction Y and through which the first body component 111 and the second body component 112 are connected to each other. In this example embodiment, the first connecting rod 251 and the second connecting rod 252 are arranged in the sub-scanning direction X. The first connecting rod 251 is disposed forward of the second connecting rod 252. The first shaft 103 and the second shaft 105 are disposed between the first connecting rod 251 and the second connecting rod 252.

When the small-diameter support 200 according to the present example embodiment is to be supported by the first shaft 73 and the second shaft 75, the rear portions of the first and second body components 111 and 112 of the body 101 are first inserted into the cut-outs 181 of the restrictor 180 of the jig body 71 as illustrated in FIG. 14, such that positioning of the small-diameter support 200 in the main scanning direction Y is determined. As illustrated in FIG. 16, the first shaft 73 is then caught between the lower and upper restricting edge portions 225 and 226 of the first small-diameter restrictors 220 of the body 101, with the result that positioning of the small-diameter support 200 in the up-down direction Z is determined. Subsequently, the second shaft 75 is caught between the first and second restricting edge portions 235 and 236 of the second small-diameter restrictors 230 of the body 101, with the result that positioning of the small-diameter support 200 in the sub-scanning direction X is determined. Determining the positioning of the small-diameter support 200 in the main scanning direction Y, the sub-scanning direction X, and the up-down direction Z in this manner causes the small-diameter support 200 to be properly supported by the first shaft 73 and the second shaft 75.

In the present example embodiment described above, the printing jig 160 includes, as illustrated in FIG. 14, the restrictor 180 provided on the jig body 71 and configured to restrict the small-diameter support 200 supported by the first shaft 73 and the second shaft 75 from moving in the main scanning direction Y. The small-diameter support 200 is thus unlikely to move in the main scanning direction Y while being supported by the first shaft 73 and the second shaft 75. Accordingly, in effecting printing on the small-diameter cylindrical substrate 6B (see FIG. 13) while rotating the small-diameter cylindrical substrate 6B using the small-diameter support 200, the present example embodiment makes the small-diameter support 200 and the small-diameter cylindrical substrate 6B unlikely to move in the main scanning direction Y.

In the present example embodiment, the restrictor 180 is provided with the cut-outs 181 into which portions of the body 101 of the small-diameter support 200 are to be inserted as illustrated in FIG. 14. The cut-outs 181 include the first edge portions 185 to be disposed on the first side (i.e., left side in this example embodiment) in the main scanning direction Y relative to the portions of the body 101 inserted into the cut-outs 181, and the second edge portions 186 to be disposed on the second side (i.e., right side in this example embodiment) in the main scanning direction Y relative to the portions of the body 101 inserted into the cut-outs 181. The first and second edge portions 185 and 186 catch the portions of the body 101 therebetween. Because the portions of the body 101 are disposed between the first and second edge portions 185 and 186 in this manner, the small-diameter support 200 is unlikely to move in the main scanning direction Y relative to the jig body 71.

In the present example embodiment, the first supported portions 213 include, as illustrated in FIG. 16, the first small-diameter restrictors 220 to restrict the small-diameter support 200 supported by the first shaft 73 and the second shaft 75 from moving in the up-down direction Z. The small-diameter support 200 is thus unlikely to move in the up-down direction Z while being supported by the first shaft 73 and the second shaft 75. Accordingly, in effecting printing on the small-diameter cylindrical substrate 6B while rotating the small-diameter cylindrical substrate 6B using the small-diameter support 200, the present example embodiment makes the small-diameter support 200 and the small-diameter cylindrical substrate 6B unlikely to move in the up-down direction Z.

In the present example embodiment, the first small-diameter restrictors 220 include the lower restricting edge portions 225 to be disposed under the first shaft 73, and the upper restricting edge portions 226 to be disposed over the first shaft 73. The lower and upper restricting edge portions 225 and 226 catch the first shaft 73 therebetween. Because the first shaft 73 is disposed between the lower and upper restricting edge portions 225 and 226 in this manner, the small-diameter support 200 is unlikely to move in the up-down direction Z relative to the first shaft 73.

In the present example embodiment, the second supported portions 214 of the small-diameter support 200 include the second small-diameter restrictors 230 to restrict the small-diameter support 200 supported by the first shaft 73 and the second shaft 75 from moving in the sub-scanning direction X. The small-diameter support 200 is thus unlikely to move in the sub-scanning direction X while being supported by the first shaft 73 and the second shaft 75. Accordingly, in effecting printing on the small-diameter cylindrical substrate 6B while rotating the small-diameter cylindrical substrate 6B using the small-diameter support 200, the present example embodiment makes the small-diameter support 200 and the small-diameter cylindrical substrate 6B unlikely to move in the sub-scanning direction X.

In the present example embodiment, the second small-diameter restrictors 230 include the first restricting edge portions 235 to be disposed on the first side (i.e., front side in this example embodiment) in the sub-scanning direction X relative to the second shaft 75, and the second restricting edge portions 236 to be disposed on the second side (i.e., rear side in this example embodiment) in the sub-scanning direction X relative to the second shaft 75. The first and second restricting edge portions 235 and 236 catch the second shaft 75 therebetween. Because the second shaft 75 is disposed between the first and second restricting edge portions 235 and 236 in this manner, the small-diameter support 200 is unlikely to move in the sub-scanning direction X relative to the second shaft 75.

In the present example embodiment, the intervals between the first and second restricting edge portions 235 and 236 narrow upward. If the second shaft 75 varies in diameter, the present example embodiment would allow the location of the second shaft 75 in the up-down direction Z with respect to the first and second restricting edge portions 235 and 236 to change in accordance with the diameter of the second shaft 75, and would thus enable the second shaft 75 to come into contact with the first and second restricting edge portions 235 and 236. Consequently, if the second shaft 75 varies in diameter, the present example embodiment would make the small-diameter support 200 unlikely to move in the sub-scanning direction X relative to the second shaft 75.

In the present example embodiment, as illustrated in FIG. 17, the body 101 of the small-diameter support 200 includes the first insertion holes 241 which are elongated holes extending in the up-down direction Z and through which the first shaft 103 is to be inserted so as to be slidable in the up-down direction Z, and the second insertion holes 242 which are elongated holes extending in the up-down direction Z and through which the second shaft 105 is to be inserted so as to be slidable in the up-down direction Z. In order to rotate the small-diameter cylindrical substrate 6B supported by the small-diameter support 200, this example embodiment includes causing the first rotary roller 121 fitted to the first shaft 103 to be suitably brought into contact with the associated first large-diameter roller 78A fitted to the first shaft 73, and causing the second rotary roller 122 fitted to the second shaft 105 to be suitably brought into contact with the associated second large-diameter roller 78B fitted to the second shaft 75. An error in assembly of the components of the printing jig 160 and/or individual differences between the components of the printing jig 160 may unfortunately interfere with suitable contact between the first rotary roller 121 and the associated first large-diameter roller 78A and/or suitable contact between the second rotary roller 122 and the associated second large-diameter roller 78B. In the present example embodiment, however, the first insertion holes 241 through which the first shaft 103 is to be inserted and the second insertion holes 242 through which the second shaft 105 is to be inserted are elongated holes extending in the up-down direction Z. This allows the first shaft 103 and the second shaft 105 to move in the up-down direction Z relative to the first insertion holes 241 and the second insertion holes 242, respectively, such that the first rotary roller 121 and the second rotary roller 122 are respectively mounted, under their weights, on the associated first large-diameter roller 78A fitted to the first shaft 73 and the associated second large-diameter roller 78B fitted to the second shaft 75. The present example embodiment is thus able to reduce or eliminate adverse effects caused by the above-mentioned assembly error and/or individual differences. Consequently, if the above-mentioned assembly error and/or individual differences has/have occurred, the present example embodiment would enable the first rotary roller 121 to suitably come into contact with the associated first large-diameter roller 78A and would enable the second rotary roller 122 to suitably come into contact with the associated second large-diameter roller 78B.

In the present example embodiment, the body 101 includes, as illustrated in FIG. 18, the first overlapping portion 201 overlapping with the first rotary roller 121 in the sub-scanning direction X as viewed in the main scanning direction Y, and the second overlapping portion 202 overlapping with the second rotary roller 122 in the sub-scanning direction X as viewed in the main scanning direction Y. With the first shaft 103 disposed at the lowermost position relative to the first insertion holes 241, the first rotary roller 121 protrudes above the first overlapping portion 201. With the second shaft 105 disposed at the lowermost position relative to the second insertion holes 242, the second rotary roller 122 protrudes above the second overlapping portion 202. Thus, when the small-diameter cylindrical substrate 6B is to be supported by the first and second shafts 103 and 105 of the small-diameter support 200, the present example embodiment enables the small-diameter cylindrical substrate 6B to come into contact with the peripheral surfaces of the first and second rotary rollers 121 and 122 without coming into contact with the body 101.

In the present example embodiment, the printing jig 160 includes, as illustrated in FIG. 12, the test printing stage 190 provided on the jig body 71 and including the test printing surface 191 on which test printing is to be carried out. Thus, if the printing jig 160 is attached to the supporting table 50, the present example embodiment would enable the test printing substrate 5 to be supported by the test printing surface 191 and to undergo test printing.

In the present example embodiment, the test printing surface 191 is disposed above the small-diameter support 200 supported by the first shaft 73 and the second shaft 75 as illustrated in FIG. 13. Thus, if the small-diameter support 200 is supported by the first shaft 73 and the second shaft 75, the present example embodiment would be able to prevent the ink heads 44 and the small-diameter support 200 from interfering with each other during test printing. Consequently, if the small-diameter support 200 is supported by the first shaft 73 and the second shaft 75, the present example embodiment would enable suitable test printing.

In the present example embodiment, the test printing surface 191 is disposed below the upper end of the small-diameter cylindrical substrate 6B supported by the small-diameter support 200. The present example embodiment is thus able to prevent the ink heads 44 and the test printing surface 191 from interfering with each other in effecting printing on the small-diameter cylindrical substrate 6B while rotating the small-diameter cylindrical substrate 6B. Consequently, the present example embodiment would enable suitable printing on the small-diameter cylindrical substrate 6B.

In each of the foregoing example embodiments, the rotator 80 is rotatable to rotate both of the first shaft 73 and the second shaft 75. Alternatively, the rotator 80 may be rotatable to rotate either the first shaft 73 or the second shaft 75. In one example, the rotator 80 may rotate the first shaft 73 without rotating the second shaft 75. In another example, the rotator 80 may rotate the second shaft 75 without rotating the first shaft 73.

The small-diameter supports 100 according to the first example embodiment and the small-diameter support 200 according to the second example embodiment each include the first rotary roller 121 fitted to the first shaft 103, and the second rotary roller 122 fitted to the second shaft 105. Alternatively, the small-diameter supports 100 and the small-diameter support 200 may each include either the first rotary roller 121 or the second rotary roller 122. In one example, the small-diameter supports 100 and the small-diameter support 200 may each include the first rotary roller 121 fitted to the first shaft 103 but may include no second rotary roller 122 fitted to the second shaft 105. In this case, the small-diameter cylindrical substrate 6B is supported by the first rotary roller(s) 121 and the second shaft(s) 105 by being brought into direct contact therewith and is thus rotated by rotation of the first rotary roller(s) 121.

The bodies 101 of the small-diameter supports 100 according to the first example embodiment and the body 101 of the small-diameter support 200 according to the second example embodiment each include two body components, i.e., the first body component 111 and the second body component 112. Alternatively, the bodies 101 of the small-diameter supports 100 and the body 101 of the small-diameter support 200 may each include one body component. In one example, the first body component(s) 111 or the second body component(s) 112 may be optional.

In each of the foregoing example embodiments, the first large-diameter rollers 78A are fitted to the first shaft 73, the second large-diameter rollers 78B are fitted to the second shaft 75, and the rotary rollers 107 are fitted to the first and second shafts 103 and 105. Alternatively, any one or more or all of the first large-diameter rollers 78A, the second large-diameter rollers 78B, and the rotary rollers 107 may be optional as long as rotational forces of the first and second shafts 73 and 75 are transmittable to the first and second shafts 103 and 105 such that the first and second shafts 103 and 105 are rotatable.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A printing jig for a printer including a supporting table, the printing jig being attachable to and detachable from the supporting table and usable to print on a cylindrical substrate while the cylindrical substrate is rotated, at least a portion of the cylindrical substrate having a cylindrical outer peripheral shape, the printing jig comprising:
a jig body to be supported by the supporting table;
a first shaft supported by the jig body and extending in a first direction;
a second shaft supported by the jig body and arranged side by side with the first shaft so as to be spaced from the first shaft at a first interval in a second direction intersecting with the first direction, the second shaft being able to, together with the first shaft, support a large-diameter cylindrical substrate having a first diameter;
a rotator to rotate at least one of the first shaft and the second shaft; and
a small-diameter support to be detachably supported by the first shaft and the second shaft, the small-diameter support being able to support a small-diameter cylindrical substrate having a second diameter smaller than the first diameter; wherein
the small-diameter support includes:
a body including:
a first supported portion to be supported by the first shaft; and
a second supported portion to be supported by the second shaft;
a first shaft supported by the body and extending in the first direction;
a second shaft supported by the body, extending in the first direction, and arranged side by side with the first shaft so as to be spaced from the first shaft at a second interval in the second direction, the second interval being shorter than the first interval, the second shaft being able to, together with the first shaft, support the small-diameter cylindrical substrate;
a first rotary roller supported by the first shaft so as to be rotatable relative to the body and movable to contact with a peripheral surface of the small-diameter cylindrical substrate and rotate in accordance with rotation of the first shaft; and
a second rotary roller supported by the second shaft so as to be rotatable relative to the body and movable to contact with the peripheral surface of the small-diameter cylindrical substrate and rotate in accordance with rotation of the second shaft.

2. The printing jig according to claim 1, further comprising a large-diameter roller fitted to at least one of the first shaft and the second shaft; wherein
a peripheral surface of the first rotary roller or the second rotary roller is movable to contact with a peripheral surface of the large-diameter roller; and
the first rotary roller or the second rotary roller is rotatable in accordance with rotation of the large-diameter roller.

3. The printing jig according to claim 2, wherein
the peripheral surface of the large-diameter roller is made of a material having a first hardness; and
the peripheral surface of the first rotary roller or the second rotary roller is made of a material having a second hardness equal to or lower than the first hardness.

4. The printing jig according to claim 1, wherein the first supported portion of the small-diameter support includes a first small-diameter restrictor to restrict the small-diameter support supported by the first shaft and the second shaft from moving in an up-down direction.

5. The printing jig according to claim 4, wherein
the first small-diameter restrictor includes:
a lower restricting edge portion to be positioned under the first shaft; and
an upper restricting edge portion to be positioned over the first shaft such that the first shaft is caught between the lower restricting edge portion and the upper restricting edge portion.

6. The printing jig according to claim 1, wherein the second supported portion of the small-diameter support includes a second small-diameter restrictor to restrict the small-diameter support supported by the first shaft and the second shaft from moving in the second direction.

7. The printing jig according to claim 6, wherein
the second small-diameter restrictor includes:
a first restricting edge portion to be positioned on a first side in the second direction relative to the second shaft; and
a second restricting edge portion to be positioned on a second side in the second direction relative to the second shaft such that the second shaft is caught between the first restricting edge portion and the second restricting edge portion.

8. The printing jig according to claim 7, wherein an interval between the first restricting edge portion and the second restricting edge portion narrows upward.

9. The printing jig according to claim 1, wherein
the body of the small-diameter support includes:
a first body component to which a first end of the first shaft and a first end of the second shaft are connected; and
a second body component which is arranged side by side with the first body component in the first direction and to which a second end of the first shaft and a second end of the second shaft are connected.

10. The printing jig according to claim 1, further comprising a restrictor provided on the jig body to restrict the small-diameter support supported by the first shaft and the second shaft from moving in the first direction.

11. The printing jig according to claim 10, wherein
the restrictor includes a cut-out into which a portion of the body of the small-diameter support is to be inserted; and
the cut-out includes:
a first edge portion to be positioned on a first side in the first direction relative to the portion of the body; and
a second edge portion to be positioned on a second side in the first direction relative to the portion of the body such that the portion of the body is located between the first edge portion and the second edge portion.

12. The printing jig according to claim 1, wherein
the body of the small-diameter support includes:
a first insertion hole which is an elongated hole extending in an up-down direction and through which the first shaft is to be inserted so as to be slidable in the up-down direction; and
a second insertion hole which is an elongated hole extending in the up-down direction and through which the second shaft is to be inserted so as to be slidable in the up-down direction.

13. The printing jig according to claim 12, wherein
the body includes:
a first overlapping portion overlapping with the first rotary roller in the second direction as viewed in the first direction; and
a second overlapping portion overlapping with the second rotary roller in the second direction as viewed in the first direction;
with the first shaft at a lowermost position relative to the first insertion hole, the first rotary roller protrudes above the first overlapping portion; and
with the second shaft at a lowermost position relative to the second insertion hole, the second rotary roller protrudes above the second overlapping portion.

14. The printing jig according to claim 1, further comprising a test printing stage provided on the jig body and including a test printing surface on which test printing is to be carried out.

15. The printing jig according to claim 14, wherein the test printing surface is above the small-diameter support supported by the first shaft and the second shaft.

16. The printing jig according to claim 14, wherein the test printing surface is below an upper end of the small-diameter cylindrical substrate supported by the small-diameter support.

17. A printer comprising:
the printing jig according to claim 1;
an ink head provided above the supporting table to discharge ink; and
an elevator to raise and lower the supporting table; wherein
with the small-diameter support supported by the first shaft and the second shaft, a central axis of the first shaft is at a higher level than a central axis of the first shaft and a central axis of the second shaft, and a central axis of the second shaft is at a higher level than the central axis of the first shaft and the central axis of the second shaft.
